(19) United States
(12) Patent Application Publication
(10) Pub. No.: US 2007/0055649 A1
(43) Pub. Date: Mar. 8, 2007

(54) Information search device, input supporting device, method, and program

(76) Inventors: Takashi Tsuzuki, Osaka (JP); Yoshiyuki Okimoto, Kyoto (JP); Tsuyoshi Inoue, Osaka (JP); Hiroshi Kutsumi, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/592,954

(22) Filed: Nov. 6, 2006

Related U.S. Application Data
(63) Continuation of application No. PCT/JP05/09405, filed on May 24, 2005.

(30) Foreign Application Priority Data
Jun. 10, 2004 (JP) 2004-173148

(51) Int. Cl. G06F 17/30

(52) U.S. Cl. 707/2

(57) ABSTRACT

An input supporting device, which supports a user's input in the case where an information search is not progressing, so that the user can promptly obtain a result of the search, and includes: an input unit that receives an input of a search keyword; a search progress management unit that monitors progress of the search in a search device; and a search condition presentation unit which obtains an appropriate search condition based on the inputted search keyword and presents the obtained search condition to the user, in the case where the search is not progressing, while the search condition presentation unit includes: a categorized knowledge storage unit in which a category and a search keyword are stored in an associated manner; a category obtainment unit that obtains a category of the inputted search keyword with reference to the categorized knowledge storage unit; a search method storage unit in which a name of a search method and a category string are stored in an associated manner; a search method obtainment unit that obtains a name of a search method based on which the obtained category can be searched with reference to the search method storage unit; a screen creation unit that converts the obtained search method name into screen information; and a display unit that displays the screen information.

### CROSS REFERENCE TO RELATED APPLICATION

This is a continuation of PCT application No. PCT/JP2005/009405 filed May 24, 2005, designating the United States of America.

### BACKGROUND OF THE INVENTION

(1) Field of the Invention

The present invention relates to an input supporting device that supports an input of search condition operated in an information search device, and a method thereof, and in particular, to a technique of supporting user's inputs in the case where an information search is not progressing.

(2) Description of the Related Art

As a technique to support an input of search condition performed in an information search device, the followings are the inventions disclosed as the conventional arts. A voice communication device is disclosed in Japanese Laid-Open Patent Application No. 11-212594. When a communication with the user is not progressing, the voice communication device examines words to be recognized and outputs a voice guidance to prompt the user to perform a voice input while presenting one or more of the words. A communication processing device is disclosed in Japanese Patent No. 3468572. In the case where an unknown word is included in an inputted sentence, the communication processing device can estimate a type (category) of the unknown word and display a list of the words that belong to the estimated category.

A search supporting device is disclosed in Japanese Open-Laid Patent Application No. 2004-102818. The search supporting device prepares for words that belong to each of the concepts that are hierarchically classified and questions that may be used for a search. When the user inputs a search-requesting sentence or word to make a search, the search supporting device presents a question in accordance with the concept to which a word extracted from the inputted sentence or word belongs, and guides the user to search using the presented question.

The conventional voice communication device as described above, however, has the following problem. The voice communication device presents one or more of the words to be recognized and outputs a voice guidance to prompt the user to perform a voice input. However, in the case where a word the user desires to input is not presented in the voice guidance, the problem is that the user cannot know whether the user can input the word that he/she desires to input.

For example, when the user does not perform any input within a certain time after the voice communication device outputs a guidance to the user “Please input a name of the team”, the voice communication device again outputs a voice guidance that goes “such as Kyojin, and Hiroshima”. The user, however, does not know whether he/she can input a team name “Yankees” and therefore cannot gain enough supports to progress the search.

As for the conventional communication processing device, the device displays a list of the words which belong to a category of the unknown word that is estimated. Therefore, in the case where plural categories are estimated for the unknown word, the number of the displayed words increases and the words other than the category that the user desires to input are also displayed. This causes a problem that it is difficult for the user to search a word that he/she desires to input, in the list of the displayed words.

For example, in the case where the user utters a sentence written in natural language such as “make a reservation for the Hotel Japan” that includes a word “Hotel Japan” which is not a target word to be recognized, the communication processing device estimates that a category of the word “Hotel Japan” is “hotel” based on the word “Hotel” and also estimates that the category is “a title of TV program” based on the word “make a reservation for”. Namely, as a result of the estimation, the communication processing device displays a list of hotels and TV programs, therefore, the user is forced to face the difficulty in searching the word that he/she desires to input, in the list of vast amounts of words that are displayed.

With regard to the conventional search supporting device, the device guides the user to make a search using the presented question. The problem is that the user cannot directly use a search-requesting sentence or word that the user has inputted on its own.

For example, in the case where data such as a word “product X”, “product Y” and questions like “What is the price of . . . ?” and “How would you like to purchase . . . ?” are prepared in the search supporting device for a concept “laptop”, after the user inputs a sentence such as “I want to know about product X” the questions such as “What is the price of product X?” and “How would you like to purchase product X?” are presented by the device so that the user is guided to search for the information related to “product X” using such questions.

Such structure can offer an excellent support in the case where the user finds it difficult or complicated to compose a question, on one hand. However, on the other hand, in the case otherwise, easiness and promptness may be degraded instead.

The present invention is conceived in view of the above problems, and an object of the present invention is to provide an input supporting device that supports user's inputs so that the user can promptly obtain a search result in the case where the user is in trouble during a search.

### SUMMARY OF THE INVENTION

In order to achieve the above object, an input supporting device according to the present invention supports an input of a search condition into an information search device that searches for information based on a search keyword inputted by a user, and that presents a result of the search, and includes: a progress monitoring unit operable to monitor progress of the search in the information search device; and a search condition presentation unit operable (i) to obtain a search condition by which the information search device can make a search, based on a last-inputted keyword, in the case where the progress monitoring unit judges that the search is not progressing, the last-inputted keyword being a keyword used for the search that is judged as not progressing, and (ii) to present the user with the obtained search condition.

The search condition presentation unit may include: a category obtainment unit operable to obtain a category corresponding to the obtained search condition, with reference to a categorized knowledge database in which a category and a search keyword are stored in an associated manner, the category indicating a type of a search keyword, and the search keyword belonging to the category; a search method obtainment unit operable to obtain a search method name corresponding to the obtained category, based on the obtained category with reference to a search method database in which a name of a search method and a category string are stored in an associated manner, the search method being a method by which the category can be searched; and a search method presentation unit operable to present the user with the obtained search method name as the search condition.

The search condition presentation unit may include a related-word obtainment unit operable to obtain a related-word corresponding to the obtained search condition, with reference to a related-word database in which information concerning a relation between words is stored; and a related-word presentation unit operable to present the user with the obtained related-word as the search condition.

As described above, the input supporting device according to the present invention presents appropriate search conditions to the user based on the search keyword inputted by the user, in the case where the search is not progressing, for example, because the user has inputted a wrong search keyword. Therefore, the user can promptly obtain a search result by specifying one search condition among the presented search conditions.

The input supporting device according to the present invention is.

The last-inputted search keyword used for obtaining the search condition may be a search keyword inputted by the user immediately before the progress monitoring unit judges that the search is not progressing. Also, the search condition obtained by the search condition presentation unit may be a search condition by which the last-inputted search keyword can be searched, or a name of an application program by which the last-inputted search keyword can be searched. Moreover, the last-inputted search keyword may be a word indicating a search method.

Preferably, the input supporting device may further include an input receiving unit operable to receive an input of the search keyword from the user, wherein the input receiving unit is operable (i) to output the inputted search keyword to the information search device in the case where the progress monitoring unit judges that the search is progressing, and (ii) to output the search keyword to the search condition presentation unit in the case where the progress monitoring unit judges that the search is not progressing.

According to the structure described above, in the case where the progress of the search gets stacked, the input supporting device presents search conditions appropriate for the search based on the search keyword inputted by the user. It is therefore possible for the user to promptly obtain a search result by specifying one search condition among the presented search conditions. In the case where it is judged that the search is progressing, the input supporting device outputs the search keyword to the search device, so that neither unnecessary supports are provided nor the promptness and easiness of the search are not degraded.

The search condition presentation unit may include: a category obtainment unit operable to obtain a category corresponding to the obtained search condition, with reference to a categorized knowledge database in which a category and a search keyword are stored in an associated manner, the category indicating a type of a search keyword, and the search keyword belonging to the category; a search method obtainment unit operable to obtain a search method name corresponding to the obtained category, based on the obtained category with reference to a search method database in which a name of a search method and a category string are stored in an associated manner, the search method being a method by which the category can be searched; and a search method presentation unit operable to present the user with the obtained search method name as the search condition.

According to the structure described above, the input supporting device presents, based on a category of the search keyword inputted by the user, names of search methods by which the category can be searched.

The search condition presentation unit may include: a related-word obtainment unit operable to obtain a related-word corresponding to the obtained search condition, with reference to a related-word database in which information concerning a relation between words is stored; and a related-word presentation unit operable to present the user with the obtained related-word as the search condition.

According to the structure described above, the input supporting device presents related-words of the search keyword based on the search keyword inputted by the user. It is therefore possible for the user to easily make a judgment for narrowing or widening the search range in order to obtain an appropriate search result in the search device.

The progress monitoring unit may be operable to obtain a history of operations performed by the user using the information search device, and to judge that the search is not progressing, in the case where the number of times that the operation passes the same menu stage amounts to or goes beyond a predetermined number of times.

In the case where the progress monitoring unit judges that the search is not progressing, the last-inputted keyword may be respective one of search keywords inputted by the user during a period from when the user's operation starts to pass the same menu stage until when the progress monitoring unit judges that the search is not progressing.

The input supporting device may further include an input receiving unit operable to receive an input of the search keyword from the user, wherein the progress monitoring unit is operable to judge that the search is not progressing, in the case where the input of the search keyword is not received for a predetermined period of time or longer.

The input supporting device may further include an input receiving unit operable to receive an input indicating that the user is in trouble, wherein the progress monitoring unit may be operable to judge that the search is not progressing, based on the user's input indicating that the user is in trouble, or based on the number of search results, or based on a degree by which the number of search results obtained for each search decreases.

According to the structure described above, the input supporting device can present various methods for judging that the user is in trouble. Therefore, it is possible to provide the user with appropriate supports for making the search progress, using one method selected from the presented methods.

Particularly by judging that the user is in trouble based on the fact that the user's operation passes the same menu stage for more than a predetermined number of times, it is possible to appropriately judge that the user is in trouble, even in the case where the search goes smoothly. Thus, by using plural search keywords, it is possible to accurately estimate search methods suitable for making the search proceed, and present the estimated search methods to the user.

The input receiving unit may include: a microphone for receiving an input of speech; and a speech recognition unit operable to recognize the speech inputted into said microphone, and to output a result of the recognition to said progress monitoring unit.

The recognition result may include a score indicating accuracy of recognition, the progress monitoring unit may be operable to judge that the search is not progressing, in the case where the score is lower than a predetermined threshold.

According to the structure described above, the user can input the search keyword into the speech recognition unit via voice, therefore, the input supporting device is suitable for an information search device that applies a voice input method.

The search condition presentation unit may include: a communication unit operable to communicate with an external device that extracts a search condition appropriate for the search, based on the last-inputted search keyword; and a search condition obtainment unit operable to transmit the last-inputted search keyword to the external device, and to receive the search condition extracted by the external device, via said communication unit.

The search condition presentation unit may include a category obtainment unit operable to obtain a category corresponding to the search condition, with reference to a categorized knowledge database in which a category and a search keyword are stored in an associated manner, the category indicating a type of a search keyword, and the search keyword belonging to the category.

A plurality of the external devices may be set outside the input supporting device, and the search condition presentation unit may include a display control unit operable to leave one search condition and delete all but the one search condition, in the case where the search condition obtainment unit receives the same search condition respectively from the external devices.

According to the structure described above, in the case where the search is not progressing, the input supporting device transmits the search keyword inputted by the user to a device on the network, and then, receives a search method from the device and displays the method, the user can easily be informed of the search method or search keywords transmitted from the device with which the user can search a desired content.

The present invention can be realized not only as the input supporting device as described above, but also as an information search device, as an input supporting method that includes, as steps, the processing executed by the characteristic units included in the input supporting device, and even as a program that causes a computer to execute these steps. Such program is surely distributable via a storage medium such as a CD-ROM and a transmission medium such as the Internet.

### FURTHER INFORMATION ABOUT TECHNICAL BACKGROUND TO THIS APPLICATION

The disclosure of Japanese Patent Application No. 2004-173148 filed on Jun. 10, 2004 including specification, drawings and claims is incorporated herein by reference in its entirety.

The disclosure of PCT application No. PCT/JP2005/009405 filed, May 24, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a functional structure of an input supporting device according to a first embodiment of the present invention;

FIG. 2 is a conceptual diagram showing an example of information stored in a categorized knowledge storage unit of the input supporting device according to the first embodiment;

FIG. 3 shows an example of implementation in categorized knowledge storage unit of the input supporting device according to the first embodiment;

FIG. 4 is a conceptual diagram showing information stored in a search method storage unit of the input supporting device according to the first embodiment;

FIG. 5 shows an example of implementation in the search method storage unit of the input supporting device according to the first embodiment;

FIG. 6 is a flowchart showing an operation performed by the input supporting device according to the first embodiment;

FIG. 7 shows an example of the search methods displayed by the input supporting device according to the first embodiment;

FIG. 8 shows an example of the structure of an input unit in the input supporting device according to the first embodiment;

FIG. 9 shows another example of the structure of the input unit in the input supporting device according to the first embodiment;

FIG. 10 shows an example of an output from a speech recognition unit in the input supporting device according to the first embodiment;

FIG. 11 shows an example of an output from a reference similarity calculation unit in the input supporting device according to the first embodiment;

FIG. 12 shows a display example of the search keywords displayed by the input supporting device according to the first embodiment;

FIG. 13 is a flowchart showing an operation of the search progress judgment processing performed by the input supporting device according to the first embodiment;

FIG. 14 shows an example of a hierarchical search according to the first embodiment;

FIG. 15 is a diagram showing a display example of a search result in the case where a search is made using the input supporting device according to the first embodiment;

FIG. 16 is a diagram showing an example of an application run button according to a variation of the first embodiment;

FIG. 17 shows an example of link data according to the variation of the first embodiment;

FIG. 18 is a block diagram showing a functional structure of the input supporting device according to a second embodiment;

FIG. 19 is a conceptual diagram showing information stored in a related-word storage unit in the input supporting device according to the second embodiment;

FIG. 20 shows an example of implementation in the related-word storage unit of the input supporting device according to the second embodiment;

FIG. 21 is a flowchart showing an operation performed by the input supporting device according to the second embodiment;

FIG. 22 shows an example of a display performed by the input supporting device according to the second embodiment;

FIG. 23 shows an example of an output from a speech recognition unit in the input supporting device according to the second embodiment;

FIG. 24 shows an example of an output from a reference similarity calculation unit in the input supporting device according to the second embodiment;

FIG. 25 is a block diagram showing a functional structure of the input supporting device according to a third embodiment;

FIG. 26 is a flowchart showing an operation performed by the input supporting device according to the third embodiment;

FIG. 27 shows an example of a display performed by the input supporting device according to the third embodiment;

FIG. 28 is a block diagram showing a functional structure of the input supporting device according to a fourth embodiment;

FIG. 29 shows an example of a display performed by the input supporting device according to the fourth embodiment; and

FIG. 30 shows an example of related-keyword information stored in a search method storage unit in the input supporting device according to the fourth embodiment.

### DESCRIPTION OF THE PREFERRED EMBODIMENT(S)

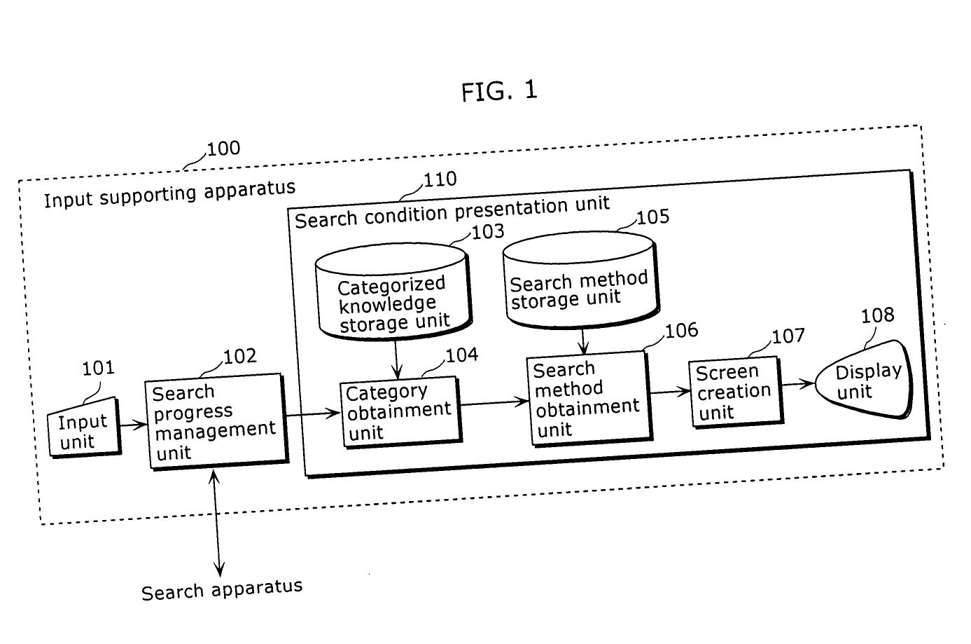

The following describes the best modes for implementing the present invention, with reference to FIGS. 1 through 25.

(First Embodiment)

The following describes the input supporting device according to the first embodiment of the present invention, with reference to the diagrams.

FIG. 1 is a block diagram showing a functional structure of the input supporting device according to the first embodiment.

The input supporting device 100 is a device that assists an input of search condition operated in an information search device, and includes an input unit 101, a search progress management unit 102 and a search condition presentation unit 110, as shown in FIG. 1.

The input unit 101 is an input device such as a keyboard, a mouse or a remote controller that receives, from the user, an input of input data that includes a search keyword. The input unit 101 outputs the input data received from the user to the search progress management unit 102.

The search progress management unit 102 is a processing unit that outputs the input data obtained from the input unit 101, and also monitors progress of the search in the search device. The search progress management unit 102 always monitors progress of a search. In the case of judging that the search is not progressing, the search progress management unit 102 outputs the input data obtained from the input unit 101 to a category obtainment unit 104 in the search condition presentation unit 110. Note that how the search progress management unit 102 judges the progress of search will be mentioned later.

The search device, though not shown in the diagram, is an information search device which searches the information that the user desires to search, based on the input data outputted from the search progress management unit 102.

The search condition presentation unit 110 is a processing unit that extracts an appropriate search condition based on the input data inputted by the user, and presents the extracted search condition to the user, in the case where the search made in the search device gets stacked. Such search condition presentation unit 110 includes a categorized knowledge storage unit 103, a category obtainment unit 104, a search method storage unit 105, a search method obtainment unit 106, a screen creation unit 107 and a display unit 108.

The categorized knowledge storage unit 103 is a storage device such as a hard disk that defines a type of a search keyword as a category, and stores a category and a search keyword or an operation instruction keyword so that they are associated with each other.

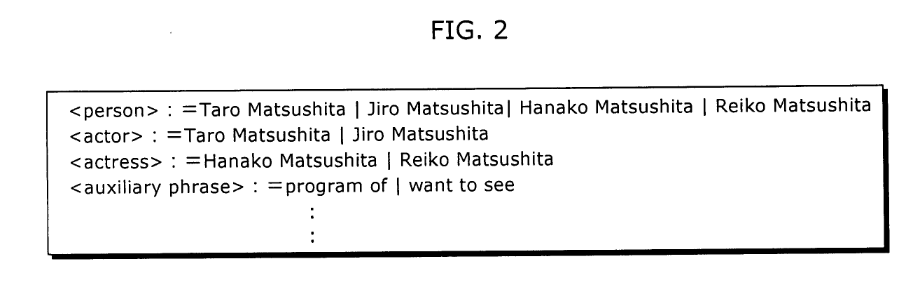

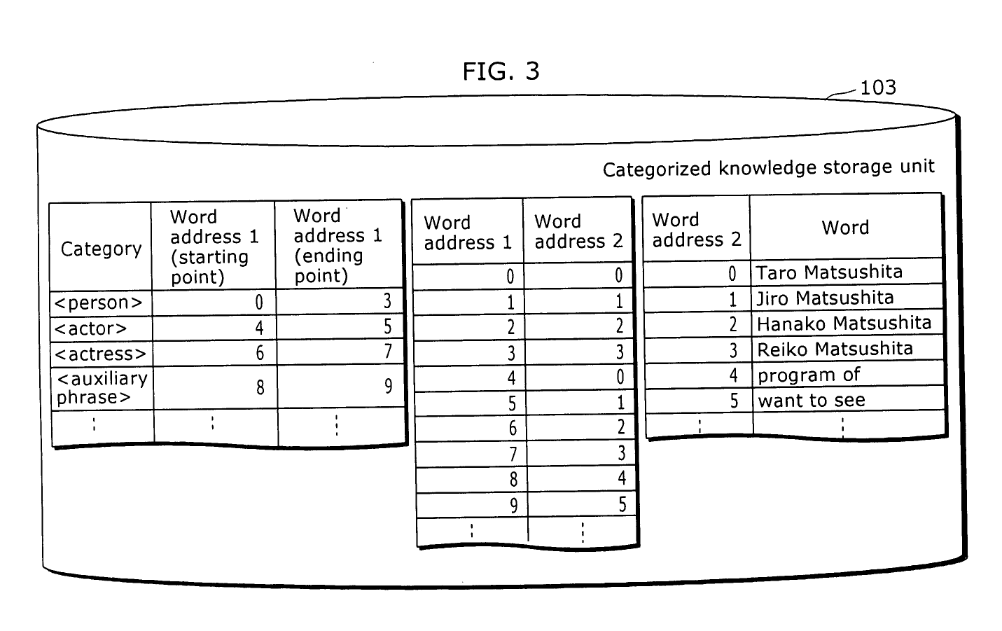

FIG. 2 is a conceptual diagram showing the information stored in the categorized knowledge storage unit 103, while FIG. 3 is a diagram showing an example of implementation in the categorized knowledge storage unit 103. Here, <person>, <actor>, <actress> and <auxiliary phrase> are respectively defined as a category, and the diagram shows how the words that belong to each category are defined. For example, it shows that the words (Taro Matsushita, Jiro Matsushita, Hanako Matsushita, and Reiko Matsushita) belong to the category <person>.

The category obtainment unit 104 is a processing unit that refers to the information in the categorized knowledge storage unit 103 so as to obtain a category that corresponds to the input data, after having received the input data from the search progress management unit 102. The category obtainment unit 104 then outputs the obtained category to the search method obtainment unit 106.

The search method storage unit 105 is a storage device such as a hard disk that stores a name of the search method (hereinafter to be referred to as “search method name”) by which the search device can search a category, in association with a sentence which is written in natural language and is represented by a category string. The search method name presents a search method that is preferable as a suggestion to the user, when the user inputs a sentence that corresponds to the search method.

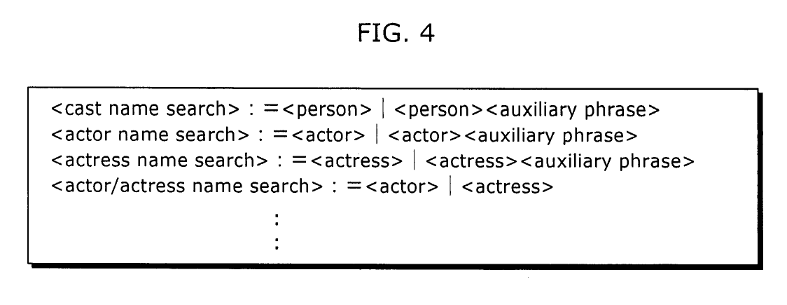

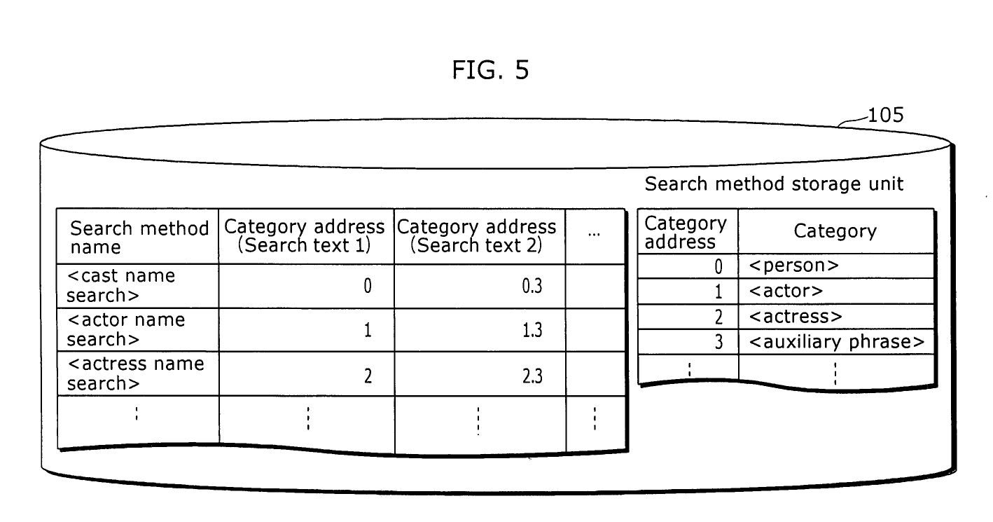

FIG. 4 is a conceptual diagram showing the information stored in the search method storage unit 105, while FIG. 5 shows an example of the implementation in the search method storage unit 105. Here, a cast member name search, an actor name search, an actress name search and an actor/actress name search are defined as search method names, and the diagram shows how search sentences, each corresponding to each search method name, are defined using categories. For example, it shows that a search sentence “(<person>, <person> <auxiliary phrase>)” corresponds to the cast member search. The concrete example shown in FIG. 5 shows that when the user inputs “Taro Matsushita” or “program in which Taro Matsushita is a cast member” in natural language, the user can receive, from the input supporting device 100, a suggestion to search “Taro Matsushita” using the cast member search.

The search method obtainment unit 106 is a processing unit that refers to the information in the search method storage unit 105 based on the category obtained by the category obtainment unit 104, and obtains a name of the search method by which the obtained category can be searched. The search method obtainment unit 106 then outputs the obtained search method name to the screen creation unit 107.

The screen creation unit 107 obtains the search method name from the search method obtainment unit 106, converts the obtained search method name into display screen information for suggesting, to the user, a search method presented by the search method name, and outputs the display screen information to the display unit 108.

The display unit 108 is a display such as a CRT display, a Liquid Crystal Display (LCD) and a Plasma Display Panel (PDP), and displays the display screen information obtained from the screen creation unit 107.

The following describes an example of an operation performed by the input supporting device 100 thus structured according to the first embodiment.

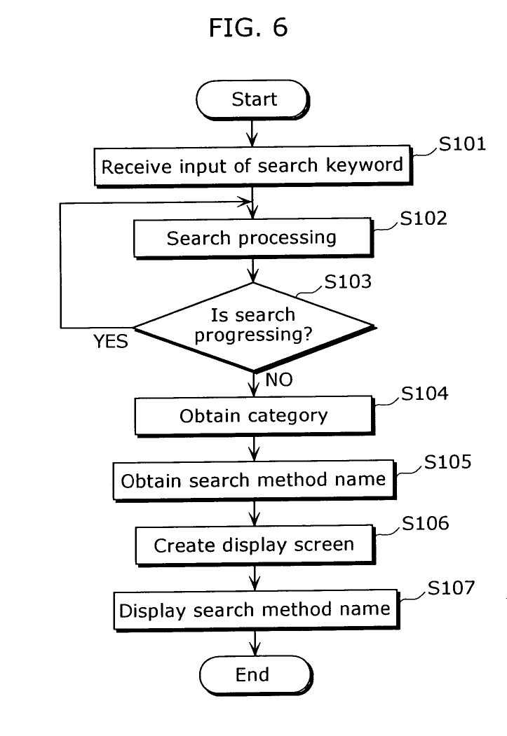

FIG. 6 is a flowchart showing the operation performed by the input supporting device 100.

Firstly, the input supporting device 100 receives an input of a search keyword from the user (Step S101). Here, the description continues using the concrete example in which it is assumed that the user inputs a search keyword “Taro Matsushita” via the input unit 101.

Next, the search progress management unit 102 outputs, to the search device, the input data inputted from the input unit 101 (Step S102), and monitors the progress of the search in the search device (Step S103).

The search progress management 102 then monitors how the search is progressing in the search device, and outputs the input data that is last-inputted, to the category obtainment unit 104. Here, a state in which a search is not progressing is the case where a search result is not definitive, and no input data is inputted for a predetermined period of time or longer after the input data is received. That is to say that, according to the above example, the search progress management unit 102 outputs, to the search device, the search keyword “Taro Matsushita” inputted from the input unit 101 and monitors the progress of the search in the search device. In the case where a search result is not definitive, and no input data is inputted a predetermined period of time or longer after the input of the search keyword, the search progress management unit 102 judges that the search is not progressing, and outputs, to the category obtainment unit 104, the search keyword “Taro Matsushita” that is last-inputted.

Having received the input data from the search progress management unit 102, the category obtainment unit 104 then refers to the information in the categorized knowledge storage unit 103, obtains a category that corresponds to the input data (Step S104), and outputs the obtained category to the search method obtainment unit 106. Here, the categorized knowledge storage unit 103 stores a category and a search keyword or an operation instruction keyword so that they are associated with each other. Assuming that the association is expressed by “(<category>(search keyword group, operation instruction keyword group))”, “(<person>(Taro Matsushita, Jiro Matsushita, Hanako Matsushita, Reiko Matsushita, . . . ))”, “(<actor>(Taro Matsushita, Jiro Matsushita))”, “(<actress>(Hanako Matsushita, Reiko Matsushita))” and “(<auxiliary phrase>, (wants to see a program of))”, as shown in FIGS. 2 and 3, are stored in the categorized knowledge storage unit 103, in the present example. Namely, according to the above case, the category obtainment unit 104 refers to the information in the categorized knowledge storage unit 103, and obtains categories “<person>” and “<actor>” which correspond to the search keyword “Taro Matsushita” inputted by the search progress management unit 102.

Having received the category obtained from the category obtainment unit 104, the search method obtainment unit 106 refers to the information in the search method storage unit 105, obtains a name of the search method by which the category can be searched (Step S105), and outputs the obtained search method name to the screen creation unit 107. Here, the search method storage unit 105 stores the search method name by which the search device can search the category, in association with a sentence which is written in a natural language and is presented by a category string.

Assuming that the association is represented by “(<search method>(<category><category><category> . . . ))”, the search method storage unit 105 stores, as shown in FIGS. 4 and 5, “(<cast member name search>, (<person>|<person><auxiliary phrase>))”, “(<actor name search>, (<actor>|<actor><auxiliary phrase>))”, “(<actress name search>, (<actress>|<actress><auxiliary phrase>))”, and “(<actor/actress name search>, (<actor>|<actress>))”. That is to say that, according to the above case, the search method obtainment unit 106 refers to the information in the search method storage unit 105, obtains a search method name (<cast member name search>, <actor name search>, by which the search keyword belonging to the respective two categories “<person>” and “<actor>” obtained by the category obtainment unit 104, and outputs the obtained search method name to the screen creation unit 107.

The screen creation unit 107 then converts the search method name obtained from the search method obtainment unit 106 into display screen information, and outputs the display screen information to the display unit 108 (Step S106). In the above example, the screen creation unit 107 converts the search method names “<cast member name search>” and “<actor name search>” into display screen information and outputs the display screen information to the display unit 108.

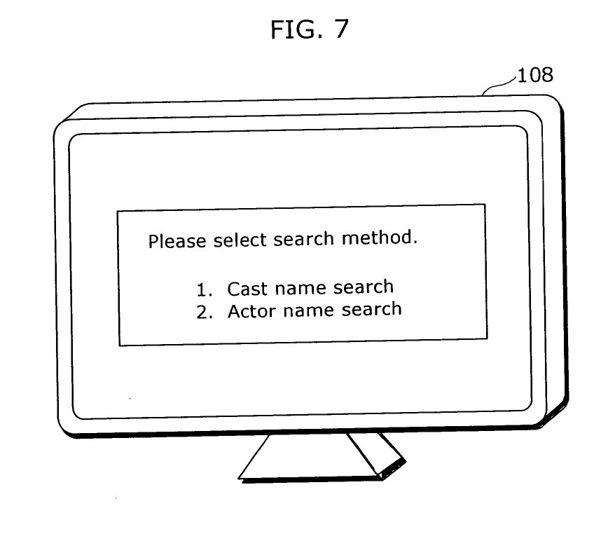

After that, the display unit 108 displays the display screen information obtained from the screen creation unit 107 (Step S107), and terminates the operation. In the above example, the display unit 108 displays the display screen information obtained by converting the search method names “<cast member name search>” and “<actor name search>”. An example of the display shown by the display unit 108 in this case is shown in FIG. 7.

Note here that in the case of judging that the search is not progressing, the search progress management unit 102 outputs the search keyword that is last-inputted to the category obtainment unit 104, however, plural search keywords inputted until the judgment is made by the search progress management unit 102 may be outputted to the category obtainment unit 104. Thus, plural search method names that the user may desire to input can be displayed. Moreover, the search method obtainment unit 106 may estimate the search method that the user desires to input based on the plural categories received from the category obtainment unit 104, and may obtain a search method name of the estimated search method from the search method storage unit 105.

In the first embodiment, the input unit 101 is described as such that applies a method of input using a keyboard, however, a method of voice input may be applied instead.

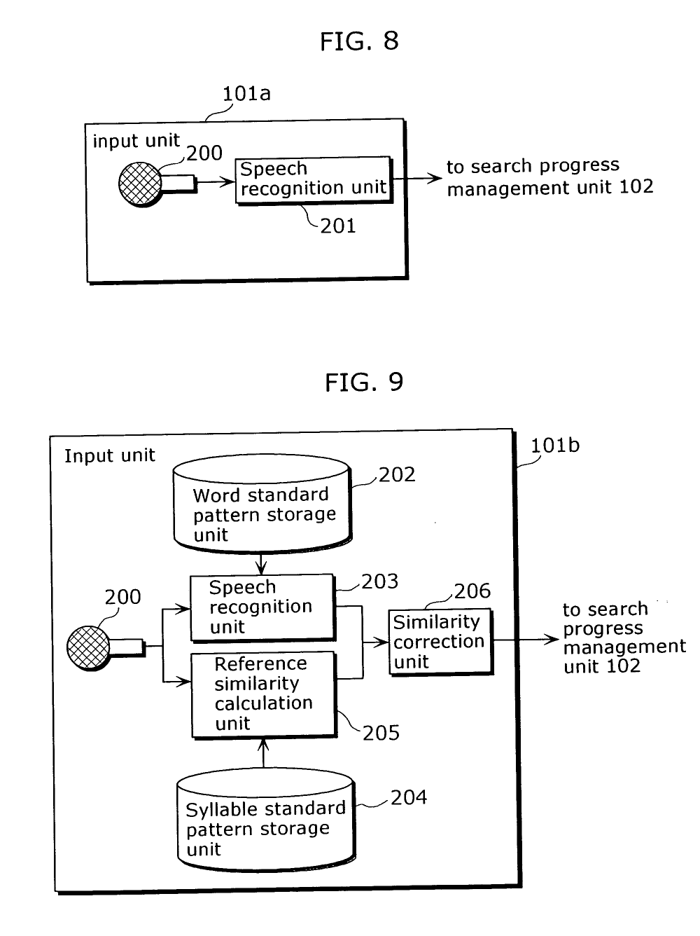

FIG. 8 is a diagram showing an example of the structure of the input unit that applies the voice input method.

In the case of using voice input, the input unit 101a has a microphone 200 and a speech recognition unit 201, as shown in FIG. 8.

The microphone 200 converts the search keyword inputted from the user into a voice signal, and outputs it to the speech recognition unit 201.

The-speech recognition unit 201 recognizes the voice signal of the search keyword obtained from the microphone 200, converts the signal into a text, and also, calculates a degree of accuracy of the result of the speech recognition and then outputs the text and a score presenting the accuracy of the recognition, to the search progress management unit 102.

Then, in the case where the next input is not performed for a predetermined period of time or longer, or the inputted score is lower than a threshold, although the search result obtained by the search device is not definitive, the search progress management unit 102 in this case judges that the search is not progressing and outputs the text inputted from the speech recognition unit 201, to the category obtainment unit 104.

The following describes, as an example, the case where the user utters a word “Taro Matsushita” to the microphone 200.

Having received an input of the uttered word “Taro Matsushita”, the microphone 200 converts it into a voice signal “taro matsushita”, and outputs the voice signal “taro Matsushita” to the speech recognition unit 201.

The speech recognition unit 201 then recognizes the voice signal “taro matsushita” inputted from the microphone 200, converts the voice signal into a text “Taro Matsushita” and calculates a degree of accuracy for the speech recognition of the voice signal “taro Matsushita”, and outputs the text “Taro Matsushita” and a score obtained as a result of the calculation to the search progress management unit 102.

In the case where the search result obtained by the search device is not definitive and also the next input is not performed for a predetermined period of time or longer, or the inputted score is lower than a threshold, the search progress management unit 102 in this case judges that the search is not progressing, and outputs the text “Taro Matsushita” to the category obtainment unit 104.

Thus, the user can search information via voice. In the case where the user cannot input the next word, not knowing what to utter after having uttered “Taro Matsushita”, or in the case where the search is not progressing because the user has inputted a word that cannot be recognized, a search method considered to be appropriate for search performed in the search device is presented based on the word “Taro Matsushita” that is recognized immediately before the search gets stacked up. In this way, the user knows what to do. The user can continue the information search by specifying a search method among the presented methods, so that the possibility that the user promptly obtains a definitive search result is heightened.

Another structure for the voice input method may be the structure shown in FIG. 9.

FIG. 9 is a diagram showing an example of another structure of the input unit in the case of using the voice input method.

According to the structure shown in FIG. 9, the input unit 101b has a microphone 200, a word standard-pattern storage unit 202, a speech recognition unit 203, a syllable standard-pattern storage unit 204, a reference similarity calculation unit 205, and a similarity correction unit 206.

The microphone 200 in this case converts the utterance of the search keyword inputted by the user into a voice signal, and outputs the voice signal to the speech recognition unit 203 and the reference similarity calculation unit 205.

The word standard-pattern storage unit 202 is a storage device such as a hard disk having an area for storing standard patterns of a word that is to be recognized and that includes a search keyword.

The speech recognition unit 203 refers to the standard patterns stored in the word standard pattern storage unit 202, recognizes a voice signal of the search keyword inputted from the microphone 200, and converts the voice signal into a text of the search keyword, as well as calculates a degree of accuracy for the result of the speech recognition, and outputs the text and a score obtained as a result of the calculation to the similarity correction unit 206.

The syllable standard-pattern storage unit 204 is a storage device such as a hard disk having an area for storing standard patterns of a syllable, a phoneme or a sub-word.

The reference similarity calculation unit 205 refers to the standard patterns stored in the syllable standard-pattern storage unit 204, obtains a text string whose score with respect to the voice signal of the search keyword inputted from the microphone 200 becomes the highest, and outputs the score obtained in this case to the similarity correction unit 206.

The similarity correction unit 206 obtains a corrected score gained by correcting the score inputted from the speech recognition unit 203 with the score inputted from the reference similarity calculation unit 205, and outputs the obtained corrected score and a text of the search keyword inputted from the speech recognition unit 203, to the search progress management unit 102.

Here, the case where the user utters a word “Taro Matsushita” to the microphone 200 is taken as an example, as is the case above.

Having received an input of the uttered word “Taro Matsushita”, the microphone 200 converts the word into a voice signal “taro matsushita”, and outputs the voice signal “taro matsushita” to the speech recognition unit 203 and the reference similarity calculation unit 205.

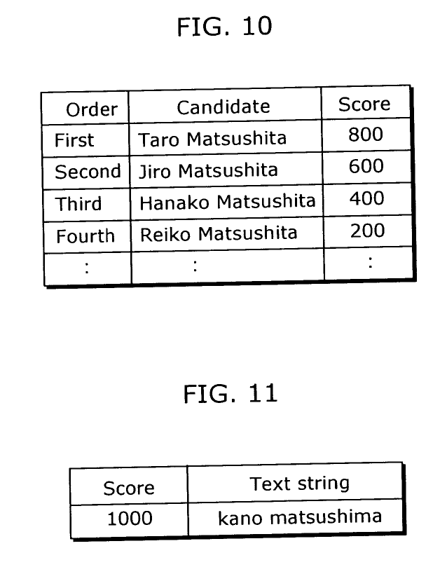

The speech recognition unit 203 refers to the word standard-pattern storage unit 202, recognizes the voice signal “taro matsushita” inputted from the microphone 200, and converts the voice signal into a text “Taro Matsushita”, as well as calculates a degree of accuracy for the recognition of the voice signal “taro matsushita” and outputs the text “Taro Matsushita” and a score “800” generated at the time of speech recognition, to the similarity correction unit 206. A concrete example of the recognition result in this case is shown in FIG. 10.

The reference similarity calculation unit 205 refers to the syllable standard pattern storage unit 204, obtains a text string whose score with regard to the voice signal “taro matsushita” inputted from the microphone 200 becomes the highest (i.e., the largest value of the score with regard to the user's utterance is obtained here, and the score varies depending on how the user utters, quality of voice, and a value unique to the user.), and outputs, for example, a score “1000” to the similarity correction unit 206. Concrete examples of a text string and a score in this case are shown in FIG. 11.

The similarity correction unit 206 corrects the score “800” inputted from the speech recognition unit 203 with the score “1000” inputted, and outputs, to the search progress management unit 102, the following: a corrected score “0.8” obtained by dividing the score “800” inputted from the reference similarity calculation unit 205 as an example by the score “1000” inputted from the reference similarity calculation unit 205; and the text “Taro Matsushita” inputted from the speech recognition unit 203.

Thus, the user can search information via voice. The text string, whose score with regard to the inputted voice becomes the highest, is obtained, and it is possible to judge with high accuracy that the user has inputted the word that cannot be recognized, by correcting the score obtained as a result of recognizing the word with the highest score, that is, by standardizing individual difference with regard to the speech recognizer. In such case, search methods are presented to the user so that the user knows what to utter; The user further can continue the search information by specifying a search method among the presented search methods.

As described so far, with the input unit which applies the voice input method and has the structure as described above, the input supporting device displays the search methods by which a related-word of the search keyword uttered by the user or a search keyword can be searched, in the case where the search is not progressing after the voice is inputted by the user. The user can thus obtain appropriate supports for continuing the search after knowing what to utter as the next input.

The user can also easily understand whether or not the uttered search keyword exists as a word to be recognized, by specifying a search method among the displayed methods and allowing the input supporting device to display a list of the search keywords with which a search can be made using the search method.

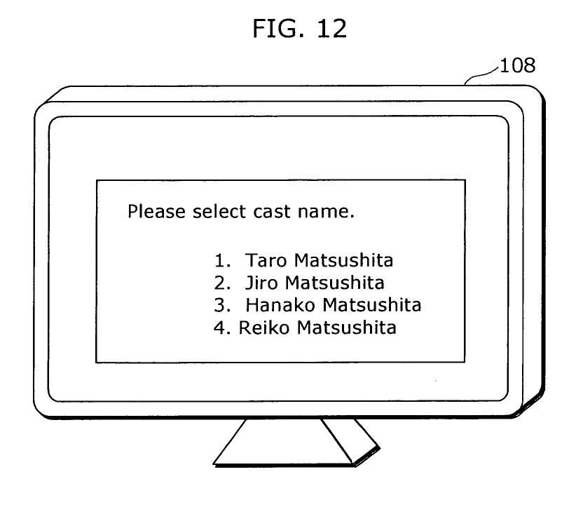

FIG. 12 shows an example of information listing the search keywords displayed by the display unit 108. For example, in the case where “1. cast member name search” is selected from the display screen information shown in FIG. 7, a list of words (see reference to FIG. 2) that belong to the category “<person>” are displayed in a menu format. The user knows, based on such information, whether or not the uttered search keyword exists as a word to be recognized, and thus can get supports for allowing the search to progress in an assured way.

Note that the first embodiment describes that the state in which the search is not progressing is the case where the search result is not definitive, and no input data is inputted for a predetermined period of time or longer after the input data is lastly received. The following describes in detail the processing performed by the search progress management unit 102 for judging the progress of the search.

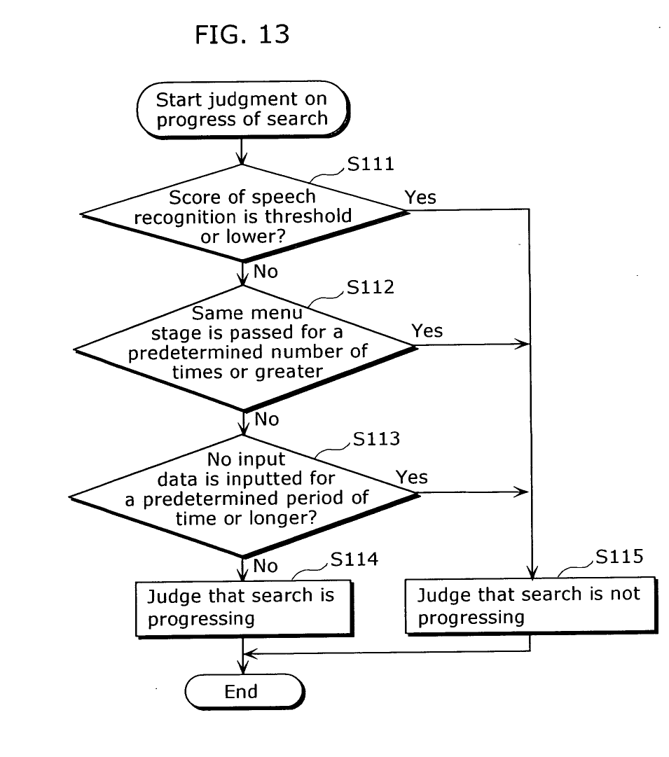

FIG. 13 is a flowchart showing the operation for judging the progress of the search in the search device.

The search progress management unit 102 firstly judges the progress of the search in the search device based on whether or not the score of the speech recognition inputted from the input unit 101a or 101b is a predetermined threshold or lower (S111). That is to say that, in the case where the score of speech recognition is the predetermined threshold or lower (Yes in S111), the search progress management unit 102 judges that the search processing performed by the search device is not progressing (S115), and terminates the processing of judging the progress of the search.

In the case where the score of speech recognition is higher than the predetermined threshold (No in 111), the search progress management unit 102 judges the progress of the search based on whether or not the number of times that the operation passes the same menu stage amounts to or goes beyond a predetermined number of times (S112). That is to say, in the case where the number of times that the operation passes the same menu stage amounts to or goes beyond a predetermined number of times (Yes in S112), the search progress management unit 102 judges that the search processing performed in the search device is not progressing (S115), and terminates the processing of judging the progress of the search.

In the case where the number of times that the operation passes the same menu stage does not amount to a predetermined number of times (No in S112), the search progress management unit 102 judges the progress of the search in the search device based on whether or not a predetermined time has elapsed after the input data is inputted from the input unit 101, for instance (S113). That is to say, in the case where no input data is inputted for a predetermined period of time or longer (Yes in S113), the search progress management unit 102 judges that the search processing performed by the search device is not progressing (S114), and terminates the processing of judging the progress of the search.

In the case where the predetermined period of time has not elapsed (No in S113), the search progress management unit 102 judges that the search processing performed by the search device is progressing (S114), and terminates the processing of judging the progress of the search. It should be noted that the search progress management unit 102 monitors progress of the search in the search device all the time, and in the case where one of the events represented in Steps 111, 112 and 113 occurs, the search progress management unit 102 starts the processing of judging progress of the search, and judges that the search is not progressing.

In this way, by judging that the search is not progressing, in the case where the number of times that the operation in the search device passes the same menu stage amounts to or goes beyond a predetermined number of times, the search progress management unit 102 can judge that the user has not searched out the information related to a desired content.

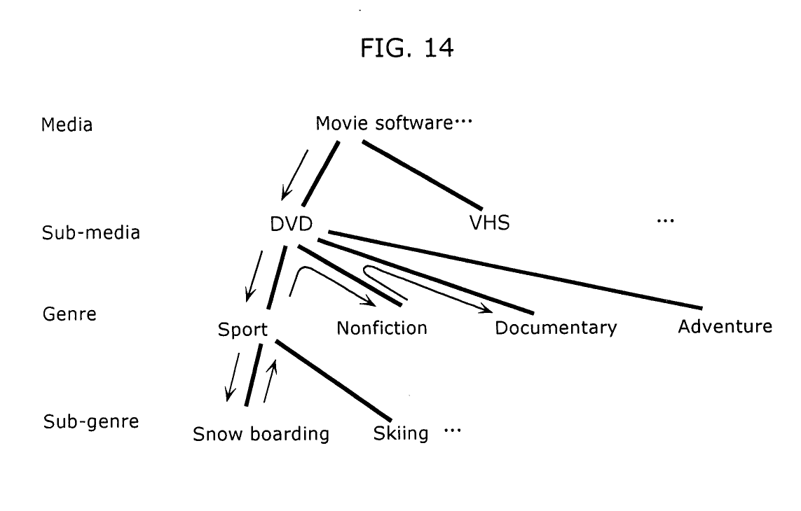

FIG. 14 is a diagram showing an example of the case where the number of times that the operation passes the same menu stage amounts to or goes beyond a predetermined number of times. The menus arranged according to each menu stage are set, for example, in the search device that searches for commercially-produced movie software. In the example, each menu is considered, for example, as a concrete search function using a search method specific to each menu or as an entrance to the search function, and after the user utters a search keyword presenting a search method, the corresponding menu shall be called. The diagram shows the case where the user, who desires to search for a DVD on which a story of an adventurer who has snow-boarded down the Kilimanjaro is recorded, utters the search keywords such as “movie software” and “DVD”, and calls the corresponding menus in a media stage and a sub-media stage so as to attempt the search. The user then utters the search keywords “sport” and “snowboard”, and calls the corresponding menus in a genre stage and sub-genre stage so as to attempt the search. Not finding the desired DVD, the user returns to the menu “DVD” in the sub-media stage, calls the menu by sequentially uttering the search keywords “nonfiction” and “documentary” so as to attempt the search.

In such case, by judging that the user has not searched out the information related to a desired content, based on the fact that a menu “DVD” is passed for a predetermined number of times or greater, the input supporting device can appropriately detect that the user is in trouble, and provide supports for making the search progress, even in the case where the speech recognition is performed without any problems and the user does not show hesitation in speech. Note that in the above example, it is judged that the user cannot search for a desired content based on the number of times the operation passes the menu “DVD”, however, a menu stage “genre” may be set as a criterion for the judgment.

In the case of judging that the search is not progressing, the search progress management unit 102 may output, to the category obtainment unit 104, the search keywords which are inputted during the time from when the operation starts to pass the same menu stage until when the judgment is made. In the above example, the search keywords such as “sport”, “nonfiction”, and “documentary” are outputted.

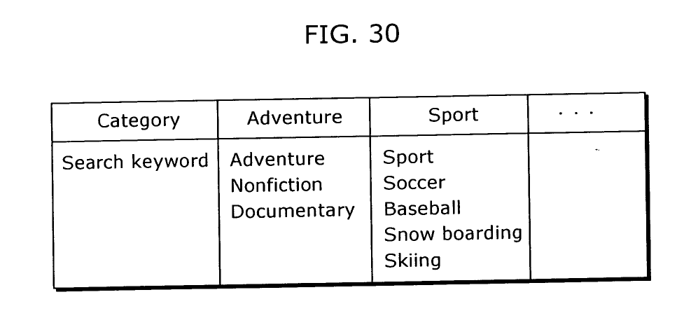

Based on this, the search method obtainment unit 106 may estimate a search method that the user desires to input, based on plural categories received from the category obtainment unit 104, and obtain a name of the search method from the search method storage unit 105. As a concrete example, related keyword information presenting the search keywords whose meanings are close within each category, as shown in FIG. 30, may be previously stored into the search method storage unit 105, so that when the search keywords “nonfiction” and “documentary” are inputted from the category obtainment unit 104, the search method obtainment unit 106 obtains, from the related keyword information as shown in FIG. 30, a search keyword “adventure” that belongs to the same category as the search keywords “nonfiction” and “documentary”. Since the obtained search keywords are presented to the user, the user can further proceed the search using a menu called by the search keyword “adventure” that is not yet attempted. In such case, it is possible to estimate a search method using plural categories so that a search method name can be obtained with accuracy.

It is described that the search progress management unit 102 judges that the search is not progressing in the case where no input data is inputted for a predetermined period of time or longer after the input data is inputted from the input unit 101 or the like. The search progress management unit 102, however, may judge that the search is not progressing in the case where no data is inputted for a predetermined period of time or longer from the time when the search device inquires the user about a search condition. Thus, it is possible to judge that the user does not know what to input in response to the inquiry from the search device.

In the case where the score that is the predetermined value or lower is sequentially inputted for a predetermined period of time or longer, the search progress management unit 102 may judge that the search is not progressing. Thus, the input supporting device can judge that the user inputs, for plural times, the keyword that is beyond the search range, and can inform the user that the user has inputted the wrong search keyword.

As described above, the input supporting device according to the first embodiment displays the search methods by which the search keyword inputted by the user can be searched, in the case where the search is not progressing because the user has inputted the wrong search keyword. Thus, the user can continue the search by specifying a search method from the search methods displayed by the input supporting device. In the case where the search is not progressing since an amount of information that hits the search condition is huge, the input supporting device presents the user with the search conditions by which the search keyword inputted by the user can be searched. The user can therefore continue the search based on the search condition that is narrowed down, by specifying a search method among the presented search methods.

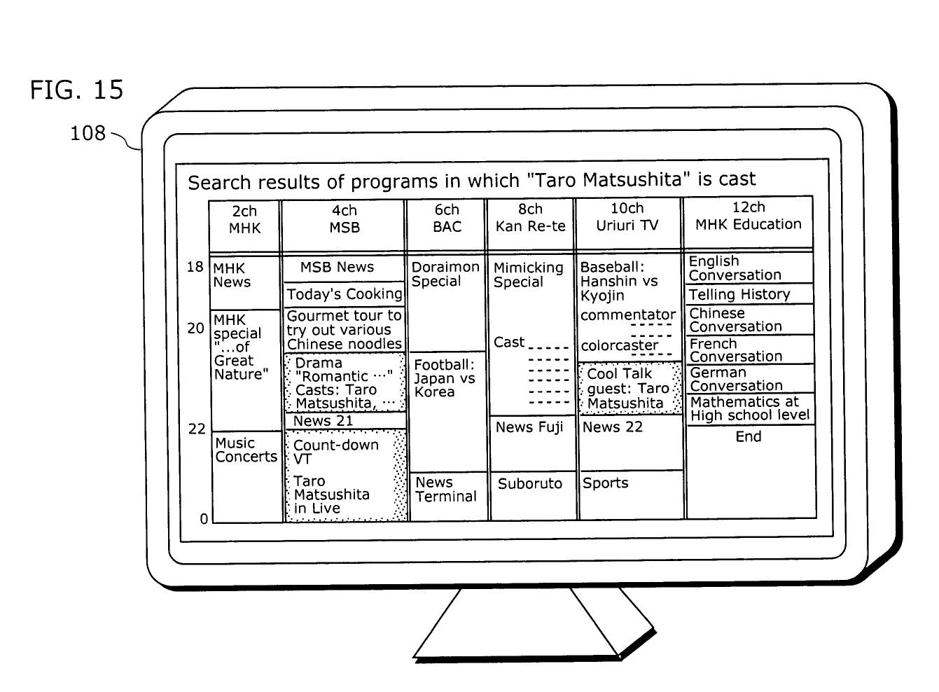

That is to say, the input supporting device according to the first embodiment presents the user with the search conditions appropriate for searching the search keyword inputted by the user, based on the inputted search keyword, in the case where the search in the search device is not going smoothly. The user can promptly obtain, from the search device, the screen displaying search results as shown in FIG. 15, by specifying a search condition among the presented search conditions.

The present embodiment describes the case where the user inputs a search keyword, however, the present invention is also applicable to the case where the user inputs a name of search method. In such case, for example, when the search is not progressing since the user has inputted a wrong search method name, for example, the input supporting device presents a search method that offers a concept located in a position higher than the search method inputted by the user so that the user can continue the search by specifying a search method among the presented search methods.

As described above, a search keyword or a search method name is inputted in natural language by the user, however, the user may select, for an input, a search keyword or a search method name from a menu, for instance.

A typical example of the screen for selecting a search keyword for input is shown in FIG. 12. On the screen, as already mentioned above, a list of words (see reference to FIG. 2) that belong to the category “person” are displayed in menu format, and when the user selects more than one word from them, the selected words are displayed as search keywords.

The present invention is surely applicable to the case where a search keyword is selected from the menu for input. In such case, as already described above, it is possible to provide the user with the supports so that the search continues, by presenting search methods in the state where the search is not progressing since a predetermined period of time has elapsed without that a word is selected from the user.

The search progress management unit 102 may also judge that the search is not progressing, based on the user's input indicating that the search is not progressing. For example, in the case where a search stagnation button is equipped to the present input supporting device, a signal presenting that the user has pressed the search stagnation button or a result obtained by recognizing a user's speech such as “The search doesn't progress” and “I don't know” indicating that the search is not progressing are raised as an example of the user's input indicating that the search is not progressing. Thus, the user can directly input, to the input supporting device, a speech indicating that the search is not progressing, and the system can judge that the search is not progressing, based on the user's direct input.

The search progress management unit 102 may judge that the search is not progressing based on the number of search results obtained by the search device. Thus, even in the case where the user cannot narrow down the search because the amount of search results is huge, the search methods appropriate for the search in the search device are presented so that the user knows what to input.

The search progress management unit 102 may judge that the search is not progressing also in the case where a degree by which the number of search results for each search made in the search device is lower than a predetermined threshold. Thus, even in the case where the user cannot efficiently reduce the number of search results, the search methods by which the number of search results can be decreased can be presented, so that the user knows what to input.

(Variation According to First Embodiment)

Although it is described that the search method storage unit 105 correlates a search method name with a category string, a name of application program and a sentence presented by a category string written in natural language may be correlated with each other instead. The search method obtainment unit 106 may obtain, from the search method storage unit 105, a name of application program based on the category obtained by the category obtainment unit 104 while the screen creation unit 107 may run the application that corresponds to the name of application program obtained by the search method obtainment unit 106, and display it on the display unit 108.

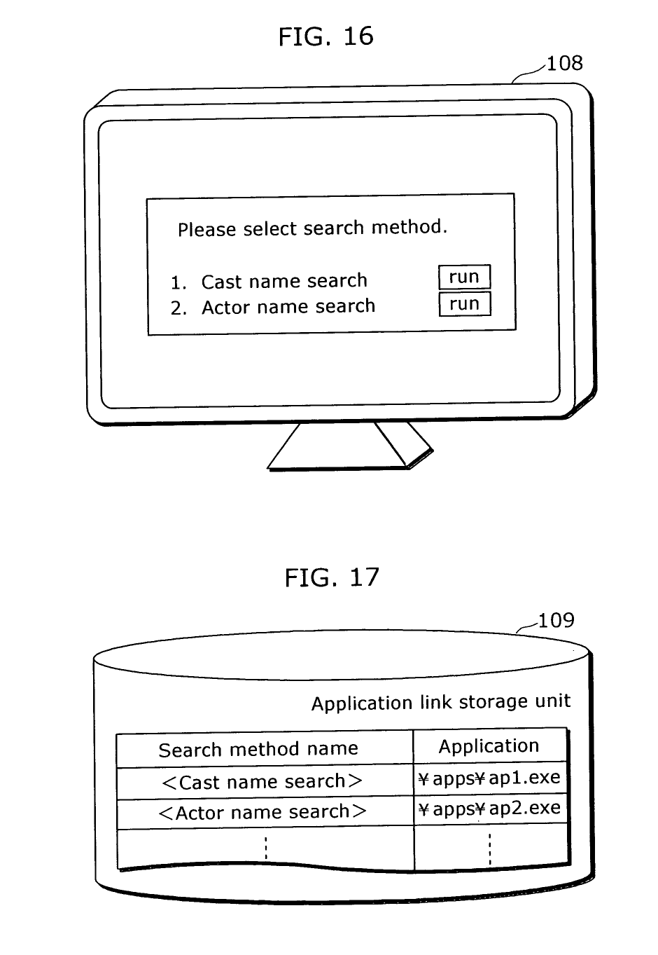

FIG. 16 is a diagram showing an example of an application run button displayed on the display unit 108 in association with a search method, as a variation of the first embodiment. In this example, a button to run an application program for executing each search method according to a name of the search method is displayed. By clicking the button, the user can run an application program and make a search based on the method corresponding to the program.

FIG. 17 is a diagram showing an example of link data to be used for running the application program that corresponds to the search method. An example of the link data stored in the application link storage unit 109 is shown in this example. The application link storage unit 109 is realized using, for example, a hard disk device (not shown in the diagram), and is set, for example, in the search condition presentation unit 110 shown in FIG. 1.

The link data is data presenting, in an associated manner, a name of a search method and a path of an application program for executing the search method. When the button is clicked, the application program whose path is indicated in the link data in association with the search method corresponded to the button runs. More precisely, the run button corresponding to “1. Cast member name search” is clicked, for example, on the screen shown in FIG. 16, the application program indicated in the corresponding path “apps ap1.exe” runs, and as a result, the screen shown in FIG. 12 is displayed.

Note that, a link for running the application program is presented in the form of button as described above, the link may be presented in such a manner that the link is inserted into the search method name, as is commonly used as a method of expressing a WEB page, or the link may be represented by a key on which a number that is displayed together with a search method name is indicated.

By applying the structure shown in the variation described above, the user can know which application program is appropriate for searching the inputted search keyword, and continue the search by running the application.

(Second Embodiment)

Next, the input supporting device according to the second embodiment of the present invention will be described with reference to the diagrams.

In the first embodiment, in the case where the user's search is not progressing, it is possible for the input supporting device to present the user with a name of the search method by which the search keyword inputted by the user can be searched. The input supporting device of the second embodiment is characteristic in that, in the case where the user gets stacked during the search, it is possible for the device to display the keywords related to the search keyword inputted by the user.

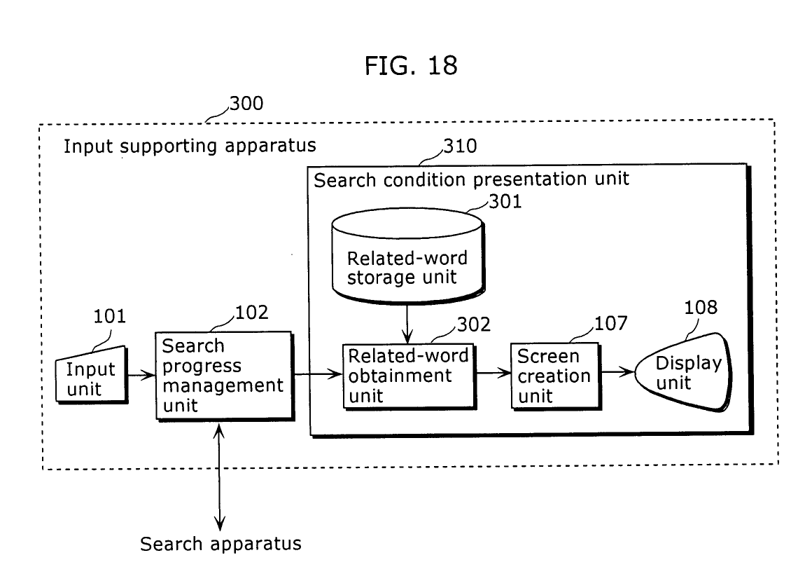

FIG. 18 is a block diagram showing a functional structure of the input supporting device according to the second embodiment.

As shown in FIG. 18, the input supporting device 300 according to the present embodiment is similar to the input supporting device 100 according to the first embodiment in that the device 300 includes the input unit 101 and the search progress management unit 102. The input supporting device 300, however, differs from the input supporting device 100 in that a search condition presentation unit 310 includes a related-word storage unit 301 and a related-word obtainment unit 302. The following mainly focuses on the difference. Note that the block with the same referential marks as described in the first embodiment shall operates in the same manner as the blocks described in the first embodiment, and the detailed description thereof will not be repeated.

The related-word storage unit 301 is a storage device such as a hard disk having an area for storing words in an associated manner. The related-word storage unit 301 stores each word as an upper-concept word or a lower-concept word.

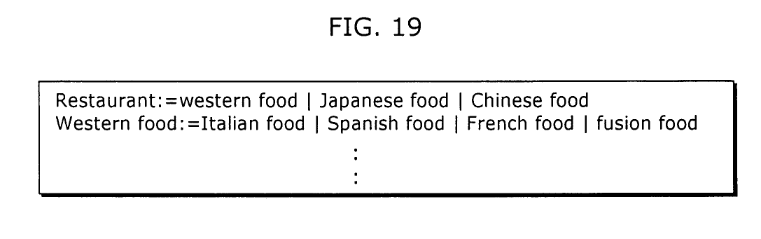

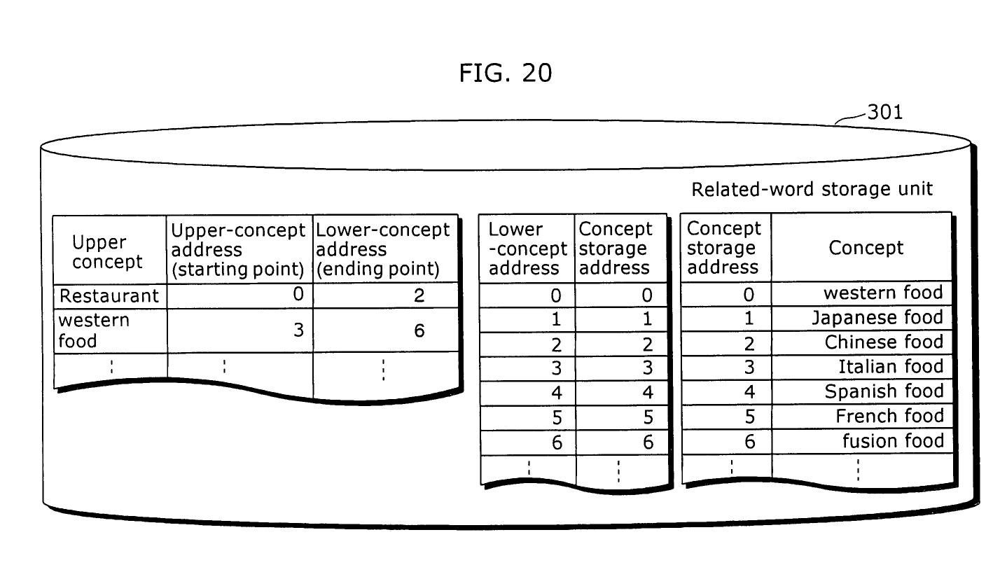

FIG. 19 is a conceptual diagram showing information stored in the related-word storage unit 301, while FIG. 20 is a diagram so showing an example of the implementation performed in the related-word storage unit 301. The example here shows that the related-word storage unit 301 stores information in the form of “(upper-concept word, (lower-concept word group))” such as (restaurant, (western food, Japanese food, Chinese food) and (western food, (Italian food, Spanish food, French food, fusion food)).

The related-word obtainment unit 302 is a processing unit that refers to the words stored in the related-word storage unit 301 and obtains a related-word that corresponds to the input data, after having received the input data from the search progress management unit 102. The related-word obtainment unit 302 then outputs the obtained related-word to the screen creation unit 107. The following describes an example of the operation performed by the input supporting device 300 structured as described above according to the second embodiment.

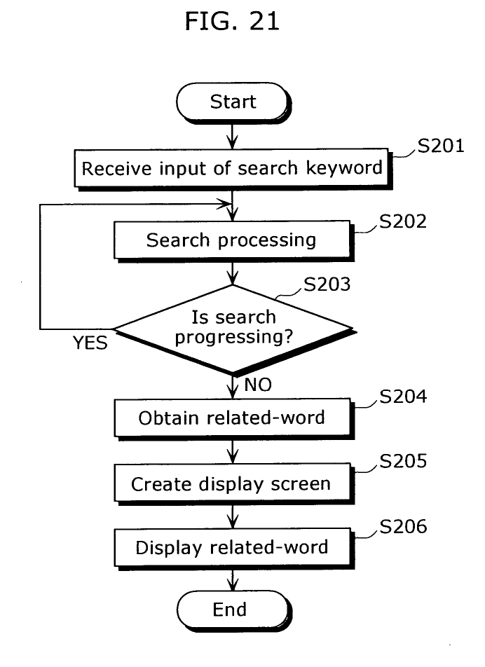

FIG. 21 is a flowchart showing the operation of the input supporting device 300.

Firstly, the input supporting device 300 receives an input of a search keyword from the user via the input unit 101 (Step S201). The description continues using a concrete example where it is assumed that the user inputs, via the input unit 101, a search keyword “western food” in order to search for a restaurant.

Next, the search progress management unit 102 outputs the input data inputted from the input unit 101, to the search device (Step 202), and monitors progress of the search in the search device (Step S203).

The search progress management unit 102 then monitors progress of the search in the search device. In the case of judging that the search is not progressing (No in Step 203), the search progress management unit 102 outputs the input data inputted immediately before the judgment, to the related-word obtainment unit 302. Here, a state in which the search is not progressing is, as is the case described in the first embodiment, the case where the search is not definitive and no input data is inputted for a predetermined period of time or longer after the input data is received. According to the above example, the search progress management unit 102 outputs, to the search device, the search keyword “western food” inputted from the input unit 101, monitors the progress of the search in the search device, judges that the search is not progressing in the case where the search result is not definitive and no search keyword is inputted for a predetermined period of time or longer after the input of the search keyword, and outputs the search keyword “western food” that is inputted immediately before the judgment, to the related-word obtainment unit 302.

Then, having received the input data from the search progress management unit 102, the related-word obtainment unit 302 refers to the words stored in the related-word storage unit 301, obtains the related-word that corresponds to the input data (Step S204), and outputs the obtained related-word to the screen creation unit 107. That is to say that, according to the above example, the related-word obtainment unit 302 refers to the related-word storage unit 301, obtains the lower-concept words “(Italian food, Spanish food, French food, fusion food)” as related-words of the search keyword “western food” inputted from the search progress management unit 102, and outputs the display screen information to the screen creation unit 107.

The screen creation unit 107 converts the related-words obtained from the related-word obtainment unit 302 into display screen information, and outputs the display screen information to the display unit 108 (Step 5205). In the above example, the screen creation unit 107 converts the related-words (Italian food, Spanish food, French food, fusion food) obtained from the related-word obtainment unit 302 into display screen information, and outputs the related words to the display unit 108.

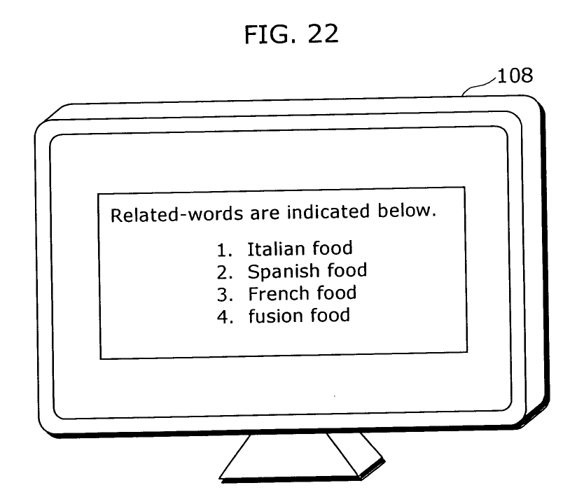

After that, the display unit 108 displays the display screen information obtained from the screen creation unit 107 (Step S206), and terminates the operation. In the above example, the display unit 108 displays the display screen information obtained as a result of converting the related-words (Italian food, Spanish food, French food, fusion food). An example of the display shown by the display unit 108 in this case is shown in FIG. 22.

Note here that, in the case of judging that the search is not progressing, the search progress management unit 102 shall output the search keyword that is inputted immediately before the judgment, to the related-word obtainment unit 302. However, plural search keywords that are inputted until judgment is made may be inputted to the related-word obtainment unit 302. In this way, plural search keywords that the user may desire to input can be displayed. The related-word obtainment unit 302 may further estimate a related-word that the user may desire to input based on the plural related-words respectively associated with the plural search keywords received from the search progress management unit 102, and output only the estimated related-words to the screen creation unit 107. In such case, it is possible to present the related-words to the user with accuracy.

As is already mentioned in the first embodiment, the input supporting device 300 according to the second embodiment may apply the method of inputting voice. The structure of the input unit in this case is as same as the structure shown in FIG. 8. Here, the case where the user utters a word “youshoku” to the microphone 200 is taken as an example.

Having received an input of the uttered word “youshoku” (meaning “western food” in Japanese), the microphone 200 converts it into a voice signal “YOUSHOKU”, and outputs the voice signal “YOUSHOKU” to the speech recognition unit 201.

Then, the speech recognition unit 201 recognizes the voice signal “YOSHOKU” inputted from the microphone 200, converts it into a text “youshoku”, calculates accuracy of the recognition with regard to the voice signal “YOUSHOKU”, and outputs the text “youshoku” and the score to the search progress management unit 102.

In the case where the search result is not definitive and the next input is not inputted for a predetermined period of time or longer, or in the case where the inputted score is smaller than a predetermined threshold, the search progress management unit 102 judges that the search is not progressing and outputs the text “youshoku” to the related-word obtainment unit 302.

Thus, the user can search information using voice. In the case where the user does not know what to utter, or in the case where the search is not progressing since the user has inputted a word that cannot be recognized, the input supporting device presents search conditions that are appropriate for the search in the search device. The user can therefore continue the search by specifying a search condition among the presented search conditions.

As is already mentioned in the first embodiment, the input supporting device 300 according to the second embodiment may apply the structure shown in FIG. 9 as another type of structure for voice input.

The case where the user utters the word “youshoku” to the microphone 200 is taken as an example here, as in the above case.

Having received an input of the uttered word “youshoku”, the microphone 200 converts it into a voice signal “YOUSHOKU” and outputs the voice signal “YOUSHOKU” to the speech recognition unit 203 and the reference similarity calculation unit 205.

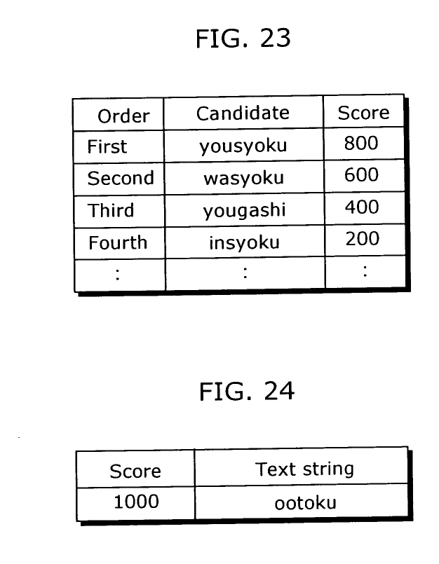

The speech recognition unit 203 refers to the word standard pattern storage unit 202, recognizes the voice signal “YOUSHOKU” inputted from the microphone 200 and converts the voice signal “YOUSHOKU” into a text “youshoku”, calculates accuracy of the recognition of the voice signal “YOUSHOKU”, and outputs a text “youshoku” and the score “800” generated at the time of speech recognition, to the similarity correction unit 206. A concrete example of the result of the recognition in this case is shown in Japanese in FIG. 23.

The reference similarity calculation unit 205 refers to the syllable standard pattern storage unit 204, obtains a text string whose score becomes the largest with regard to the voice signal “YOUSHOKU” inputted from the microphone 200 (i.e., the largest value of the score with regard to the user's utterance is obtained here, and the score varies depending on how the user utters, quality of voice, and a value unique to the user), and outputs, for example, a score “1000” to the similarity correction unit 206. Concrete examples of the text string and the score in this case are shown in FIG. 24.

The similarity correction unit 206 corrects the score “800” inputted from the speech recognition unit 203 with the score “1000” inputted from the reference similarity calculation unit 205, and outputs a corrected score “0.8” which is obtained, for example, by dividing the score “800” inputted from the speech recognition unit 203 by the score “1000” inputted from the reference similarity correction unit 206, together with the text “youshoku” inputted from the speech recognition unit 203, to the search progress management unit 102.

Thus, the user can search information using voice. Since the text string whose score becomes the largest with regard to the inputted voice is obtained, and by correcting, with the largest score, the score obtained as a result of the recognition of the word, that is, by standardizing the individual difference with respect to the speech recognizer, it is possible to judge with accuracy that the user has inputted a word that cannot be recognized. In such case, search conditions are presented to the user so that the user knows what to utter. The user can further continue the information search by specifying a search method.

The input supporting device 300 according to the second embodiment may also perform the judgment on progress of search as described in the first embodiment.

Note that in the second embodiment, it is described that the related-word storage unit 301 stores words in such a manner that upper-concept word is associated with lower-concept words, while the related-word obtainment unit 302 obtains, from the related-word storage unit 301, the lower-concept words corresponding to the input data received from the search progress status management unit 102, and outputs the lower-concept words to the screen creation unit 107. However, the related-word storage unit 301 may store synonyms in an associated manner while the related-word obtainment unit 302 may obtain synonyms corresponding to the input data received from the search progress management unit 102, and output the obtained synonyms to the screen creation unit 107.

Thus, in the case where the number of search results obtained based on the search keyword inputted by the user is small, the user can know a search keyword with which the search can be performed in the search device and which has the same meaning as that of the inputted search keyword. As a result, the number of drop-outs in the information search may be reduced.

It is also described that the related-word obtainment unit 302 obtains the lower-concept words corresponding to the input data received from the search progress management unit 102 and outputs the obtained lower-concept words to the screen creation unit 107. The related-word obtainment unit 302 may, however, obtain an upper-concept words corresponding to the input data received from the search progress management unit 102 and outputs the obtained upper-concept words to the screen creation unit 107.

Thus, in the case where the number of search results based on the search keyword inputted by the user is small, the user can search information within a wider range of search in the search device, by inputting the presented upper-concept word.

The related-word obtainment unit 302 may also switch a category of the word obtained from the related-word storage unit 301, among the categories such as upper-concept word, lower-concept word, and synonym, according to the number of search results obtained by the search device. Thus, the user may automatically know a search keyword based on which an appropriate number of search results can be obtained.

As described above, according to the input supporting device according to the second embodiment, in the case where the search is not progressing since the number of the search results obtained based on the search keyword inputted by the user is huge, the words which fall into the category of lower-concept word or the category of synonym of the search keyword inputted by the user are presented to the user so that the user can input a search keyword for easily reducing the number of search results.

Also, in the case where the search is not progressing since the number of search results obtained based on the search keyword inputted by the user is small, the words which fall into the category of upper-concept word or the category synonym are presented to the user so that the user can input a keyword for easily increasing the number of search results.

(Third Embodiment)

The following describes the input supporting device according to the third embodiment of the present invention, with reference to the diagrams.

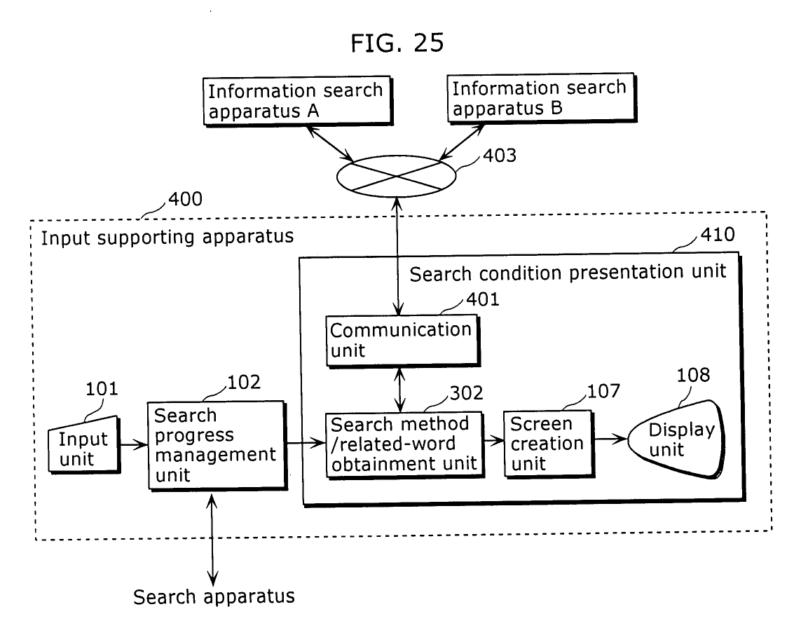

FIG. 25 is a block diagram showing a functional structure of the input supporting device according to the third embodiment.

As shown in FIG. 25, the input supporting device 400 according to the third embodiment is similar to the input supporting device 100 described in the first embodiment or the input supporting device 300 described in the second embodiment in that the input supporting device 400 includes the input unit 101 and the search progress management unit 102. However, the input supporting device 400 differs from the input supporting devices 100 and 300 in that a search condition presentation unit 410 includes a communication unit 401 and a search method/related-word obtainment unit 402. The following mainly focuses on the difference. Note that the same referential marks are assigned to the same components as those described in the first and second embodiments, and the detailed description thereof will not be repeated here.

The communication unit 401 is a communication interface for communicating with information search devices A and B on a network 403.

The search method/related-word obtainment unit 402 is a processing unit that receives input data from the search progress management unit 102, transmits, via the communication unit 401, the received input data to the information search devices A and B on the network 403, and obtains search method names or related-words from the information search devices A and B via the communication unit 401. After obtaining the search method names or related-words from the information search devices A and B, the search method/related-word obtainment unit 402 outputs the obtained search method names or related-words to the screen creation unit 107.

The information search devices A and B respectively hold search method names or related-words, and extract, based on the search keyword transmitted from the input supporting device 400, the search method names appropriate for the search keyword or the related-words of the search keyword, and transmits the extracted search method names or related-word to the input supporting device 400.

The following describes an example of the operation performed by the input supporting device 400 structured as described above according to the third embodiment.

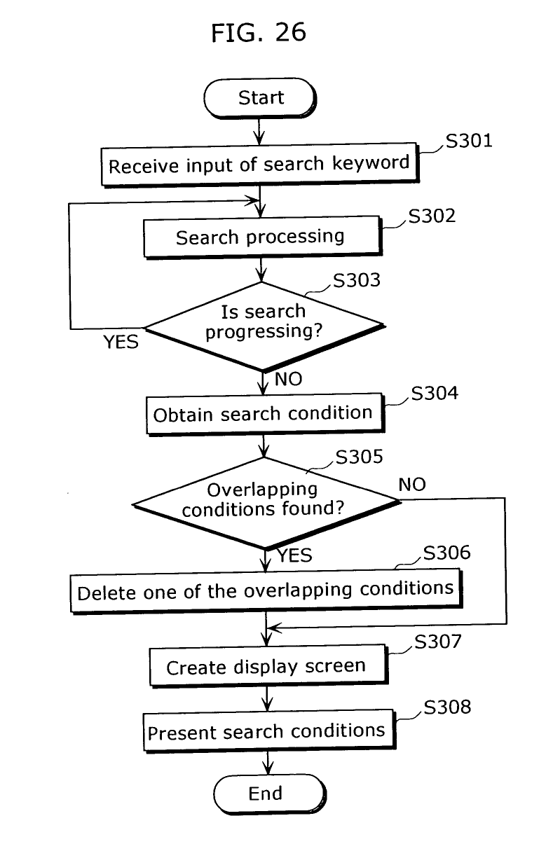

FIG. 26 is a flowchart showing the operation performed by the input supporting device 400.

Firstly, the input supporting device 400 receives an input of a search keyword from the user via the input unit 101 (Step S301). The description continues using a concrete example where it is assumed that the user inputs a search keyword “western food” via the input unit 101in order to search for a restaurant.

Next, the search progress management unit 102 outputs, to the search device, the input data inputted from the input unit 101 (Step S302), and monitors progress of the search in the search device (Step S303).

In the case of judging that the search is not progressing (No in Step S303), the search progress management unit 102 then monitors the progress of the search in the search device, and outputs the input data that is inputted immediately before the judgment, to the related-word obtainment unit 402, as is the case described in the first and second embodiments. Here, as is already mentioned in the first and second embodiments, a state in which a search is not progressing is the case where a search result in not definitive and no input data is inputted for a predetermined period of time or longer after the input data is received. That is to say that, according to the above example, the search progress management unit 102 outputs, to the search device, the search keyword “western food” inputted from the input unit 101, monitors the progress of the search in the search device. In the case where a search result is not definitive and no input data is inputted for a predetermined period of time or longer after the input of the search keyword, the is search progress management unit 102 judges that the search is not progressing, and outputs, to the search method/related-word obtainment unit 402, the search keyword “western food” that is inputted immediately before the judgment.

Having received the input data from the search progress management unit 102, the search method/related-word obtainment unit 402 then transmits, via the communication unit 401, the received input data to the information search devices A and B on the network 403, obtains the search method names or related-words corresponding to the input data, from the information search devices A and B via the communication unit 401 (Step S304), and outputs the obtained search method names or related-words to the screen creation unit 107. That is to say that, according to the above example, the search method/related-word obtainment unit 402 transmits, via the communication unit 401, the search keyword “western food” to the information search devices A and B on the network 403. The search method/related-word obtainment unit 402 then obtains the related-words “(Italian food, Spanish food)” and “(French food, fusion food)” respectively from the information search devices A and B, and outputs the obtained related words “(Italian food, Spanish food)” and “(French food, fusion food)” to the screen creation unit 107.

The screen creation unit 107 judges whether or not there is an overlap between the search method names and the related-words (i.e. search conditions) obtained from the search method/related-word obtainment unit 402 (Step S305). This is because the search condition obtained from the information search device A may overlap with the search condition obtained from the information search device B.

In the case where no overlapping conditions are found (No in Step S305), the screen creation unit 107 converts the search method names or the related words obtained from the search method/related-word obtainment unit 402 directly into display screen information, and outputs the display screen information to the display unit 108.

In the case where overlapping conditions are found (Yes in Step S305), the screen creation unit 107 puts them into one by deleting one of the overlapping search conditions (Step S306), and then, converts the search method names or related-words obtained from the search method/related-word obtainment unit 402 into display screen information and outputs it to the display unit 108 (Step S307). Thus, it is possible to reduce the number of search method names or related-words to be displayed on the display screen, and the search method names or related-words can be displayed in such a way that the user can easily see them.

After that, the display unit 108 displays the display screen information obtained from the screen creation unit 107 (Step S308), and terminates the operation.

Note here that, in the case of judging that the search is not progressing, the search progress management unit 102 outputs the search keyword inputted immediately before the judgment, to the search method/related-word obtainment unit 402. However, plural search keywords that are inputted until the judgment is made may be inputted into the search method/related-word obtainment unit 402. Thus, it is possible to display plural search keywords that the user may desire to input. The search method/related-word obtainment unit 402 may estimate the search method name or related-word that the user may desire to input based on the plural search method names or related-words corresponding to the plural search keywords received from the search progress management unit 102. In such case, it is possible to present, with certainty, the user with the estimated search method names or related words.

The input supporting device 400 according to the third embodiment may be structured so that the input unit 101 has the structure as shown in FIG. 8 or 9, and may apply the method of voice input, as already mentioned in the first and second embodiments.

Note that the third embodiment describes that the search method/related-word obtainment unit 402 obtains, via the communication unit 401, search method names or related-words from the information search devices A and B on the network 403. However, the search method/related-word obtainment unit 402 may further obtain, via the communication unit 401, device names or device identifiers in addition to the search method names or related-words, from the information search devices A and B on the network 403. In this case, the search method/related-word obtainment unit 402 outputs the obtained device names and the obtained search method name or related-words in such a manner that they are associated with each other, to the screen creation unit 107. The screen creation unit 107 converts the device name and the search method name or related-word received from the search method/related-word obtainment unit 402 into display screen information in such a manner that the device name and the search method or related-word are associated with each other, and outputs the display screen information to the display unit 108.

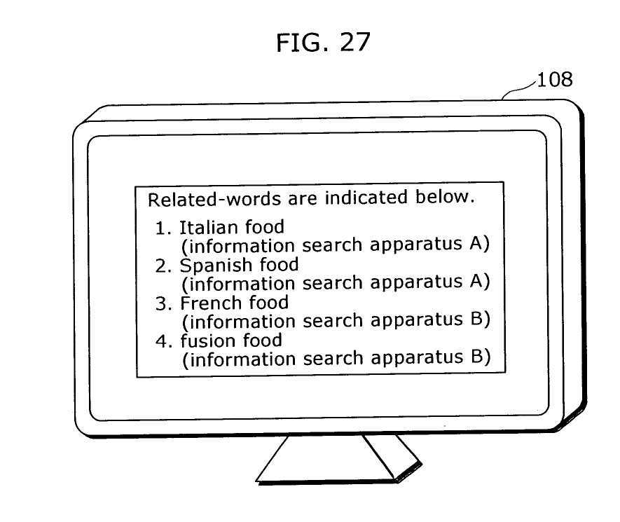

According to the above example, the search method/related-word obtainment unit 402 obtains information from the information search devices A and B in a form of “(device name, related-word)” such as “(information search device A, (Italian food, Spanish food))” and “(information search device B, (French food, fusion food))”. After the obtainment of the information, the search method/related-word obtainment unit 402 outputs the obtained “(information search device A, (Italian food, Spanish food))” and “(information search device B, (French food, fusion food))” to the screen creation unit 107, converts the received “(information search device A, (Italian food, Spanish food))” and “(information search device B, (French, international))” into display screen information, and outputs the display screen information to the display unit 108. An example of the display shown by the display unit 108 in this case is shown in FIG. 27.

Having obtained, via the communication unit 401, the search method names or related-words, and the device identifiers from the respective information search devices A and B on the network 403, the search method/related-word obtainment unit 402 may convert each of the obtained device identifiers into a device name recognizable by the user, and output the device name in association with the search method or related-word to the screen creation unit 107. Thus, the user can grasp the device on the network 403 and the search method or search keyword, based on which the user can easily search a desired content.

As described above, in the case where the search is not progressing, the input supporting device according to the third embodiment transmits the input data inputted by the user to the devices on the network, and then, receives search methods or related-words from the respective devices and display them, it is possible for the user to grasp the search methods or related-words based on which the user can easily search for a desired content in the respective devices on the network.

In the case where the search is not progressing, the input supporting device transmits the input data inputted from the user, to the devices on the network, and then, receives search methods or related-words and device names or device identifiers from the respective devices on the network, the user can grasp the devices on the network and the search method or the search keyword, based on which the user can easily searches for a desired content.

(Fourth Embodiment)

The following describes the input-supporting device according to the fourth embodiment of the present invention, with reference to the diagrams.

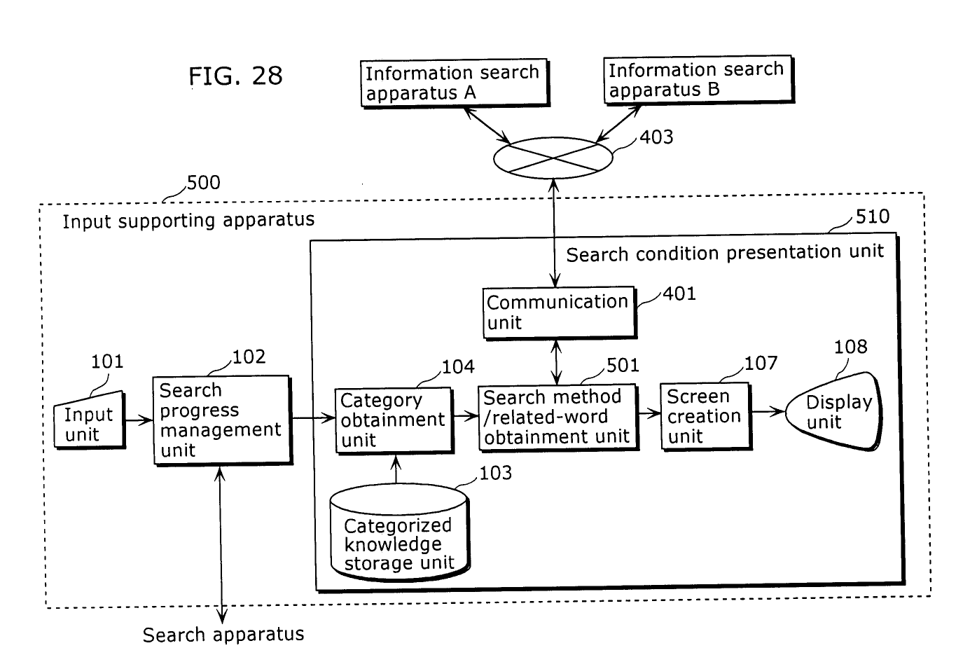

FIG. 28 is a block diagram showing a functional structure of the input supporting device according to the fourth embodiment.

As shown in FIG. 28, the input supporting device 500 according to the fourth embodiment is almost as same as the input supporting device 400 described in the third embodiment. The input supporting device 500, however, differs from the input supporting device 400 in that a search condition presentation unit 501 includes the category obtainment unit 104, the categorized knowledge storage unit 103 and a search method/related-word obtainment unit 501. The following mainly focuses on the difference. Note that the same referential marks are assigned to the same components as those described in the first through third embodiments, and the detailed description thereof will not be repeated here.

The search method/related-word obtainment unit 501 is a processing unit that transmits, via the communication unit 401, the category or search keyword obtained by the category obtainment unit 104 to the information search devices A and B on the network 403, and obtains search method names or related-words from the information search devices A and B, via the communication unit 401. After the obtainment, via the communication unit 401, of the search method names or related-words from the information search devices A and B. the search method/related-word obtainment unit 501 then outputs the obtained search method names or related-words to the screen creation unit 107.

The information search devices A and B respectively hold the search method names and the related-words, extract, based on the category or search keyword transmitted from the input supporting device 500, the search method names, or related-words of the search keyword, based on which the category can be searched, and then, transmits them to the input supporting device 500.

The following describes an example of the operation performed by the input supporting device 500 structured as described above according to the fourth embodiment. Note that the operation of the input supporting device 500 is as same as the operation shown in the flowchart in FIGS. 6 and 26, therefore, the diagram thereof shall be omitted.

Firstly, the input supporting device 500 receives, via the input unit 101, an input of a search keyword from the user. Here, the description continues using a concrete example where it is assumed that the user has inputted a search keyword “Taro Matsushita” via the input unit 101.

Next, the search progress management unit 102 outputs the input data inputted from the input unit 101 to the search device, and monitors progress of the search in the search device. In the case of judging that the search is not progressing, the search progress management unit 102 outputs the input data that is inputted immediately before the judgment. As is already mentioned in the first through third embodiments, a state in which a search is not progressing is the case where a search result in not definitive and no input data is inputted for a predetermined period of time or longer after the input data is received. That is to say that the search progress management unit 102 outputs, to the search device, the search keyword “Taro Matsushita” inputted from the input unit 101. In the case where no input data is inputted for a predetermined period of time or longer, the search progress management unit 102 judges that the search is not progressing, and outputs, to the category obtainment unit 104, the search keyword “Taro Matsushita” that is inputted immediately before the judgment.

Then, having received the input data from the search progress management unit 102, the category obtainment unit 104 refers to the categorized knowledge storage unit 103, obtains a category corresponding to the input data, and outputs the obtained category to the search method/related-word obtainment unit 501. The categorized knowledge storage unit 103 stores a category, and a search keyword or an operation instruction keyword in an associated manner. In the concrete example, as shown in FIGS. 2 and 3, it is assumed that the categorized knowledge storage unit 103 stores such information in a form of “(<category>, (search keyword group, operation instruction keyword group))” such as “(<person>, (Taro Matsushita, Jiro Matsushita, Hanako Matsushita, Reiko Matsushita, . . . ))”, “(<actor>, (Taro Matsushita, Jiro Matsushita))”, “(<actress>, (Hanako Matsushita, Reiko Matsushita))”, and “(<auxiliary phrase>, (wants to see a program of))”. Namely, according to the above example, the category obtainment unit 104 obtains the category “(<person>, <actor>)” corresponding to the search keyword “Taro Matsushita” inputted from the search progress management unit 102, with reference to the categorized knowledge storage unit 103.

Having received the category obtained from the category obtainment unit 104, the search method/related-word obtainment unit 501 transmits, via the communication unit 401, the received category to the information search devices A and B on the network 403. Having obtained, via the communication unit 401, search method names or related-words from the information search device A and the like on the network 403, the search method/related-word obtainment unit 501 outputs the obtained search method names or related-words to the screen creation unit 107. In the above .example, the search method/related-word obtainment unit 501 obtains the category “(<person>, <actor>)” from the category obtainment unit 104, and then transmits, via the communication unit 401, the category “(<person>, <actor>)” to the information search devices A and B. The search method/related-word obtainment unit 501 further obtains a search method name “<cast member name search>, <actor name search>” respectively from the information search devices A and B, and outputs the obtained method names to the screen creation unit 107.

The operation thereafter is as same as the one described in the first embodiment, so that the detailed description thereof will not be repeated here.

Note that it is described that in the case of judging that the search is not progressing, the search progress management unit 102 outputs, to the category obtainment unit 104, the search keyword that is inputted immediately before the judgment. The search progress management unit 102, however, may output plural search keywords that are inputted until the judgment is made. Thus, it is possible to display a plurality of search method names or related-words that the user may desire to input. The search method/related-word obtainment unit 501 may further estimate the search method name that the user may desire to input, based on the plural categories received from the category obtainment unit 104 and the search methods obtained via the communication unit 401, and specify a search method name. In such case, it is possible to obtain, with accuracy, a search method name.

The input supporting device 500 according to the fourth embodiment, as is the case of the first through third embodiments, may be structured so that a structure of the input unit 101 has the structure shown in FIGS. 8 or 9, and may apply a method of inputting voice.

In the fourth embodiment, as is the case of the third embodiment, the search method/related-word obtainment unit 501 may obtain, via the communication unit 401, a device name or a device identifier in addition to a search method name or a related-word, from the information-search devices A and B on the network. In this case, the search method/related-word obtainment unit 501 outputs, to the screen creation unit 107, the obtained device name and search method name or related-word so that they are associated with each other, while the screen creation unit 107 converts the device name, and the search method name or related-word obtained from the search method/related-word obtainment unit 501 into display screen information, and outputs the display screen information to the display unit 108.

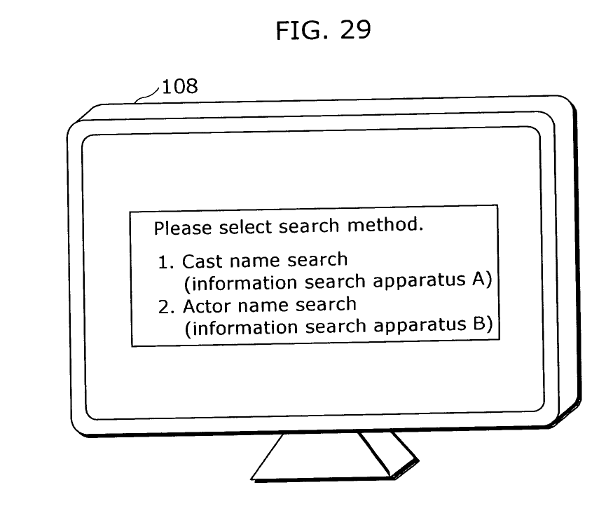

According to the above example, the search method/related-word obtainment unit 501 obtains information in a form of “(device name, search method name)”, such as “(information search device A, <cast member name search>)” and “(information search device B, <actor name search>)”, and outputs them to the screen creation unit 107. The screen creation unit 107 converts the received “(information search device A, <cast member name search>)” and “(information search device B, <actor name search>)” into display screen information, and outputs the display screen information to the display unit 108. An example of the display shown by the display unit 108 in this case is shown in FIG. 29.

As is the case described in the third embodiment, having obtained, via the communication unit 401, a search method name or a related-word, and a device identifier respectively from the information search devices A and B on the network, the search method/related-word obtainment unit 501 may convert the obtained device identifier into a device name recognizable by the user, and output the device name and the search method or related-word so that they are associated with each other, to the screen creation unit 107. Thus, the user can grasp the device on the network 403 and the search method or search keyword, based on which the user can easily search for a desired content.

As is also the case described in the third embodiment, in the case where a search method name and a related-word inputted from the search method/related-word obtainment unit 501 overlap with each other, the screen creation unit 107 may put the overlapped information together so as to convert it into display screen information, and output the display screen information to the display unit 108. Thus, it is possible to reduce the number of search method names or related-words to be displayed on the display screen, and the search method names or related-words can be displayed in such a way that the user can easily see them.

As described above, in the case where the search is not progressing since the user cannot think of any appropriate search keywords to be inputted, the input supporting device according to the fourth embodiment displays related-words of the search keyword inputted by the user, or search method names based on which the search keyword can be searched. The user can therefore know the search methods or search keywords based on which the user can easily search for a desired content.

In the case where the search is not progressing since the number of search results obtained based on the search keyword inputted by the user is small, the input supporting device transmits a category of the search keyword inputted by the user to a device on the network, and then, receives and displays a search method based on which the category can be searched, as well as a device name or a device identifier. It is possible for the user to know a search method based on which the user can easily search for a desired content in the device on the network.

In the case where the search is not progressing since the number of search results obtained based on the search keyword inputted by the user is small, the input supporting device transmits the category of the search keyword inputted by the user to the device on the network, receives and displays a search method based on which the category can be searched, as well as a device name or a device identifier. It is therefore possible for the user to specify a search method name in the device on the network so as to make a search.

As described above, the input supporting device according to the present invention is described based on each of the embodiments, however, the present invention is surely not limited to these embodiments.

For example, in each of the embodiments, an input supporting device and a search device are shown as independent components, however, the present invention may be realized as a single information search device having such components.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

In the case where a search processing gets stacked, the input supporting device according to the present invention can present search methods or related-words to which a keyword that the user desires to search belongs, so as to support the user rapidly obtain the search results. Such input supporting device is useful as an HDD recorder, a DVD recorder a TV, an audio component, a terminal that searches information by accessing the Internet, or the like.

1. An input supporting device which supports an input of a search condition into an information search device that searches for information based on a search keyword inputted by a user, and that presents a result of the search, said input supporting device comprising:
a progress monitoring unit operable to monitor progress of the search in the information search device; and
a search condition presentation unit operable (i) to obtain a search condition by which the information search device can make a search, based on a last-inputted keyword, in the case where said progress monitoring unit judges that the search is not progressing, the last-inputted keyword being a keyword used for the search that is judged as not progressing, and (ii) to present the user with the obtained search condition.

2. The input supporting device according to claim 1,
wherein the last-inputted search keyword used for obtaining the search condition is a search keyword inputted by the user immediately before said progress monitoring unit judges that the search is not progressing.

3. The input supporting device according to claim 1,
wherein the search condition obtained by said search condition presentation unit is a search condition by which the last-inputted search keyword can be searched.

4. The input supporting device according to claim 1,
wherein the search condition obtained by said search condition presentation unit is a name of an application program by which the last-inputted search keyword can be searched.

5. The input supporting device according to claim 1,
wherein said search condition presentation unit includes:
a category obtainment unit operable to obtain a category corresponding to the obtained search condition, with reference to a categorized knowledge database in which a category and a search keyword are stored in an associated manner, the category indicating a type of a search keyword, and the search keyword belonging to the category;
a search method obtainment unit operable to obtain a search method name corresponding to the obtained category, based on the obtained category with reference to a search method database in which a name of a search method and a category string are stored in an associated manner, the search method being a method by which the category can be searched; and
a search method presentation unit operable to present the user with the obtained search method name as the search condition.

6. The input supporting device according to claim 1,
wherein said search condition presentation unit includes:
a related-word obtainment unit operable to obtain a related-word corresponding to the obtained search condition, with reference to a related-word database in which information concerning a relation between words is stored; and
a related-word presentation unit operable to present the user with the obtained related-word as the search condition.

7. The input supporting device according to claim 1,
wherein said progress monitoring unit is operable to obtain a history of operations performed by the user using the information search device, and to judge that the search is not progressing, in the case where the number of times that the operation passes the same menu stage amounts to or goes beyond a predetermined number of times.

8. The input supporting device according to claim 7,
wherein in the case where said progress monitoring unit judges that the search is not progressing, the last-inputted keyword is respective one of search keywords inputted by the user during a period from when the user's operation starts to pass the same menu stage until when said progress monitoring unit judges that the search is not progressing.

9. The input supporting device according to claim 1, further comprising
an input receiving unit operable to receive an input of the search keyword from the user,
wherein said progress monitoring unit is operable to judge that the search is not progressing, in the case where the input of the search keyword is not received for a predetermined period of time or longer.

10. The input supporting device according to claim 1, further comprising
an input receiving unit operable to receive an input of the search keyword from the user,
wherein said input receiving unit is operable (i) to output the inputted search keyword to the information search device in the case where said progress monitoring unit judges that the search is progressing, and (ii) to output the search keyword to said search condition presentation unit in the case where said progress monitoring unit judges that the search is not progressing.

11. The input supporting device according to claim 10,
wherein said input receiving unit includes:
a microphone for receiving an input of speech; and
a speech recognition unit operable to recognize the speech inputted into said microphone, and to output a result of the recognition to said progress monitoring unit.

12. The input supporting device according to claim 11,
wherein the recognition result includes a score indicating accuracy of recognition,
said progress monitoring unit is operable to judge that the search is not progressing, in the case where the score is lower than a predetermined threshold.

13. The input supporting device according to claim 1,
wherein said search condition presentation unit includes:
a communication unit operable to communicate with an external device that extracts a search condition appropriate for the search, based on the last-inputted search keyword; and
a search condition obtainment unit operable to transmit the last-inputted search keyword to the external device, and to receive the search condition extracted by the external device, via said communication unit.

14. The input supporting device according to claim 1,
wherein said search condition presentation unit includes
a category obtainment unit operable to obtain a category corresponding to the search condition, with reference to a categorized knowledge database in which a category and a search keyword are stored in an associated manner, the category indicating a type of a search keyword, and the search keyword belonging to the category.

15. The input supporting device according to claim 13,
wherein a plurality of the external devices are set outside said input supporting device, and
said search condition presentation unit includes
a display control unit operable to leave one search condition and delete all but the one search condition, in the case where said search condition obtainment unit receives the same search condition respectively from the external devices.

16. The input supporting device according to claim 13,
wherein a plurality of the external devices are set outside said input supporting device,
said search condition obtainment unit is further operable to receive an identifier for identifying the respective external devices, and
said search condition presentation unit is operable to present the user with the extracted search condition and the identifier in an associated manner.

17. The input supporting device according to claim 1,
wherein the last-inputted search keyword is a word indicating a search method.

18. The input supporting device according to claim 1, further comprising
an input receiving unit operable to receive an input indicating that the user is in trouble,
wherein said progress monitoring unit is operable to judge that the search is not progressing, based on the user's input indicating that the user is in trouble.

19. The input supporting device according to claim 1,
wherein said progress monitoring unit is operable to judge that the search is not progressing, based on the number of search results.

20. The input supporting device according to claim 1,
wherein said progress monitoring unit is operable to judge that the search is not progressing, based on a degree by which the number of search results obtained for each search decreases.

21. An information search device which searches information based on a search keyword inputted by a user, and presents a result of the search, said device comprising:
a progress monitoring unit operable to monitor progress of the search; and
a search condition presentation unit operable (i) to obtain a search condition by which the information search device can make a search, based on a last-inputted keyword, in the case where said progress monitoring unit judges that the search is not progressing, the last-inputted keyword being a keyword used for the search that is judged as not progressing, and (ii) to present the user with the obtained search condition.

22. An input supporting method for an input supporting device which supports an input of a search condition into an information search device that searches information based on a search keyword inputted by a user, and that presents a result of the search, said method comprising:
a progress monitoring step of monitoring progress of the search in the information search device; and
a search condition presentation step of (i) obtaining a search condition by which the information search device can make a search, based on a last-inputted keyword, in the case where said progress monitoring unit judges that the search is not progressing, the last-inputted keyword being a keyword used for the search that is judged as not progressing, and (ii) presenting the user with the obtained search condition.

23. A program for an input supporting device which supports an input of a search condition into an information search device that searches information based on a search keyword inputted by a user, and that presents a result of the search, said program causing a computer to execute:
a progress monitoring step of monitoring progress of the search in the information search device; and
a search condition presentation step of (i) obtaining a search condition by which the information search device can make a search, based on a last-inputted keyword, in the case where said progress monitoring unit judges that the search is not progressing, the last-inputted keyword being a keyword used for the search that is judged as not progressing, and (ii) presenting the user with the obtained search condition.
